(19) United States
(12) Patent Application Publication
(10) Pub. No.: US 2018/0121075 A1
(43) Pub. Date: May 3, 2018

(54) FREEHAND OBJECT MANIPULATION

(71) Applicant: Microsoft Technology Licensing, LLC, Redmond, WA (US)

(72) Inventors: Ana Ruth Resendez Rodriguez, Redmond, WA (US); Andrew Michael Casey, Redmond, WA (US); Laurentiu Pavel, Bellevue, WA (US); Ron Mondri, Bellevue, WA (US); Ian William Mikutel, Redmond, WA (US); Jason Howard Hartman, Woodinville, WA (US)

(73) Assignee: Microsoft Technology Licensing, LLC, Redmond, WA (US)

(21) Appl. No.: 15/445,429

(22) Filed: Feb. 28, 2017

Related U.S. Application Data
(60) Provisional application No. 62/414,641, filed on Oct. 28, 2016.

(51) Int. Cl. G06F 3/0488; G06F 3/0484

(52) U.S. Cl. CPC G06F 3/04883; G06F 3/04845

(57) ABSTRACT

The intelligent detection and manipulation of objects via freehand input is provided herein to enable users greater and more intuitive control of objects interacted with via freehand inputs. Users are enabled to expose the values of various features of objects and to constrain those features to remain at a given value or convert to a given value and remain there as the user continues to interact with the object via freehand inputs.

### CROSS-REFERENCES TO RELATED APPLICATIONS

The present disclosure claims priority to U.S. Provisional Patent Application No. 62/414,641 filed Oct. 28, 2016, the disclosure of which is hereby incorporated by reference in its entirety.

### BACKGROUND

Users create content in productivity applications with a variety of input tools with various benefits and tradeoffs associated with those tools. For example, a user may draw a geometric shape with a stencil tool or freehand via a pen tool or a line tool. The stencil tool provides crisper lines and faster insertion of the shape, but the freehand tools allow greater customization and less knowledge of the productivity application's drawing stencils. For example, a user may freehand draw an isosceles, right, equilateral, obtuse, or acute triangle without having to select from individual stencils for each type of triangle, but will need to worry about the straightness of those lines, the angles at which they connect (and whether they connect), and their individual lengths; which are aspects handled seamlessly by various stencil tools. Moreover, stopping to select (or to hunt for) a stencil tool can interrupt the user's drawing session, as will the user stopping to adjust properties of the stencil object via a dialog box, which degrades the user's drawing experience and lengthens the time it takes to create a shape to the user's specification.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Systems and methods are provided herein to enable improved usability of productivity applications that enables the intelligent detection and manipulation of objects via freehand input. As a user makes freehand input in the productivity application, it is determined whether the freehand input corresponds to an object, such as a geometric shape, and the freehand input will be converted into a gesture to affect that object. In various aspects, the freehand input is applied in association with the object to modify that object, without requiring the user to access a menu to adjust the object. For example, to refine a shape object in the canvas of the productivity application (e.g., a closed polygon, an open polygon) the user applies freehand input to display features of the object, such as, for example, line segment lengths, an angle of a given vertex, etc. A user is also enabled to apply freehand input to set or modify constraints on the object, such as, for example, by drawing a square in one corner of a polygon to indicate that it is to define a right angle, applying tick marks on two or more sides of the polygon to indicate they are to be the same length, applying an arc in a corner of the polygon and writing a value of the arc (in radians or degrees) that the corner is to define, adding arrow marks on sides of the polygon to indicate that the sides are to be parallel, etc. Moreover, the user is enabled to modify the object via freehand input by dragging vertices to new positions in the canvas and the modifications to the object, in various aspects, will respect user-set constraints or notify a user when a constraint is updated in response to the modification.

By employing the present disclosure, an improved user experience is provided, where the user is enabled to input and refine objects via freehand input—without having to switch authoring tools or access menus—faster, more accurately, and more efficiently than before.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1 illustrates a block diagram of a system enabled to accept document content inputs in an electronic authoring environment;

FIGS. 2A and 2B illustrate the detection of an object entered via freehand input;

FIGS. 3A-3H illustrate the display of various features in relation to an associated object;

FIGS. 4A and 4B illustrate manipulation of an object via freehand input;

FIGS. 5A-5D illustrate the manipulation of an object that has one or more features constrained;

FIGS. 6A and 6B illustrate the input of constraints on stroke lengths;

FIGS. 7A and 7B illustrate the input of constraints on angles;

FIG. 8 is a flowchart showing general stages involved in an example method for providing intelligent detection and manipulation of objects via freehand input;

FIG. 9 is a block diagram illustrating physical components of a computing device with which examples may be practiced;

FIGS. 10A and 10B are block diagrams of a mobile computing device with which aspects may be practiced; and

FIG. 11 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Systems and methods are provided herein to enable improved usability of productivity applications that enable the intelligent detection and manipulation of objects via freehand input. As a user makes freehand input in the productivity application, it is determined whether the freehand input corresponds to an object, such as a geometric shape, and the freehand input will be converted into a gesture to affect that object. In various aspects, the freehand input is applied in association with the object to modify that object, without requiring the user to access a menu to adjust the object. For example, to refine a shape object in the canvas of the productivity application (e.g., a closed polygon, an open polygon) the user applies freehand input to display features of the object, such as, for example, line segment lengths, an angle of a given vertex, etc. A user is also enabled to apply freehand input to set or modify constraints on the object, such as, for example, by drawing a square in one corner of the triangle to indicate that it is to define a right angle, applying tick marks on two or more sides of the triangle to indicate they are to be the same length, applying an arc in a corner of the triangle and writing a value of the arc (in radians or degrees) that the corner is to define, etc. Moreover, the user is enabled to modify the object via freehand input by dragging vertices to new positions in the canvas and the modifications to the object, in various aspects, will respect user-set constraints or notify a user when a constraint is updated in response to the modification—including removing the constraint.

By employing the present disclosure, an improved user experience is provided, where the user is enabled to input and refine objects via freehand input—without having to switch authoring tools or access menus—faster, more accurately, and more efficiently than before. Additionally, because the user is not required to switch authoring tools, less system memory and fewer processing resources are expended to author content in the productivity application, and the functionality of the computing device used to provide the productivity application is thereby expanded and improved.

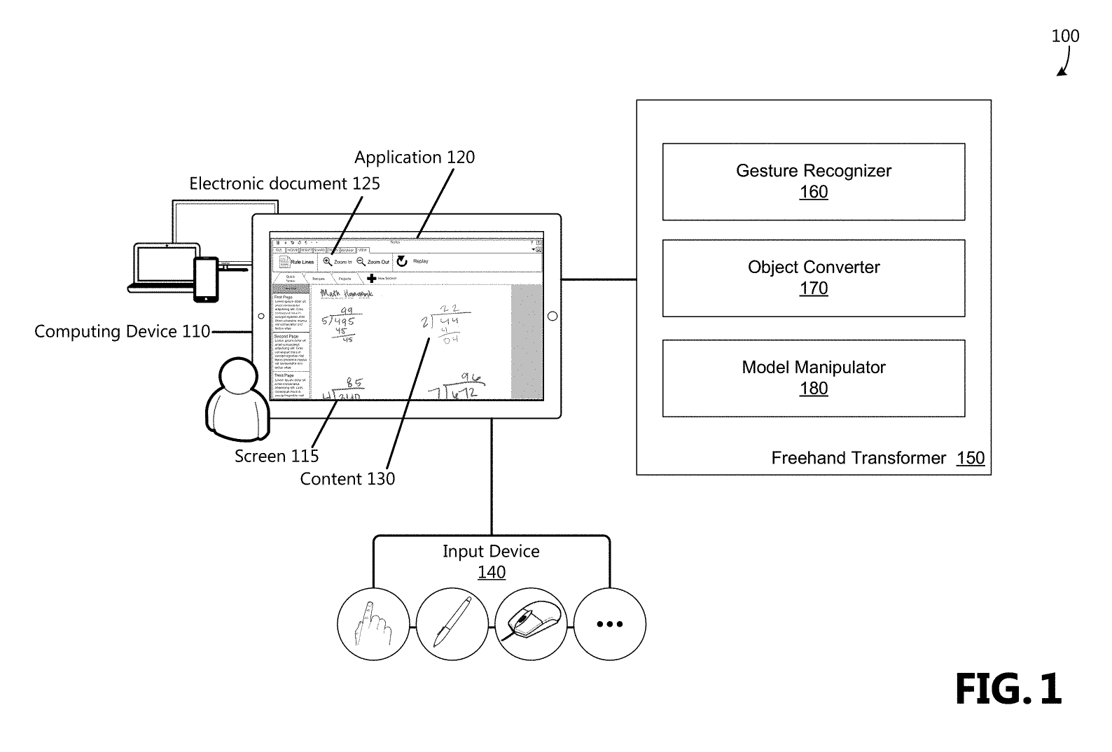

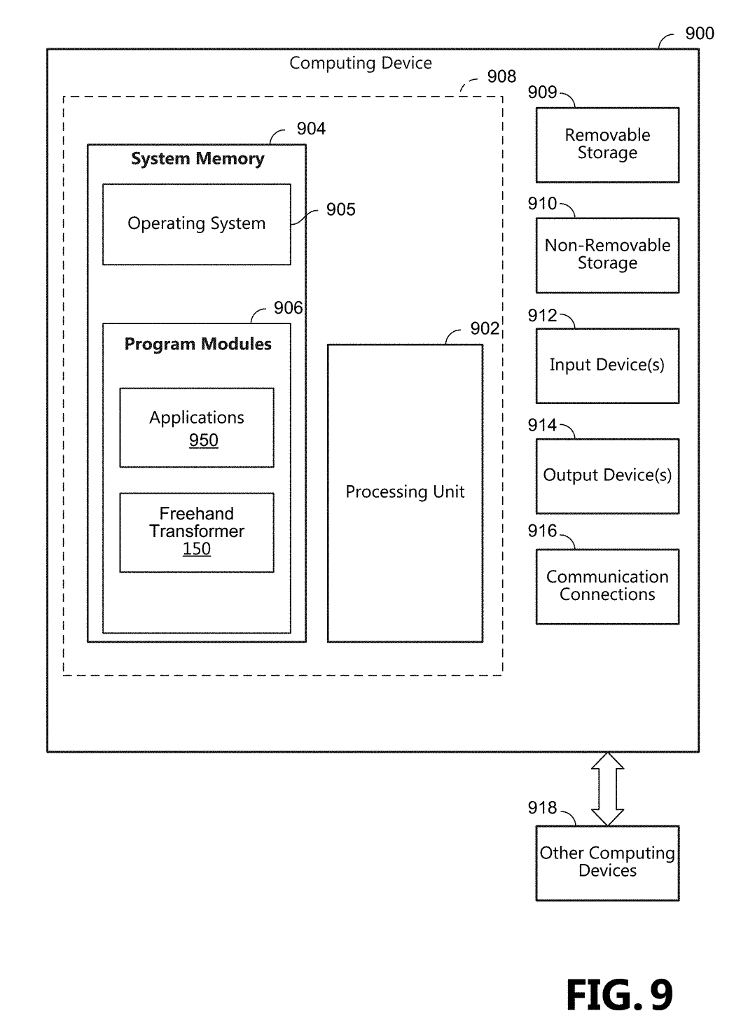

With reference now to FIG. 1, a block diagram of one example environment 100 in communication with a freehand transformer 150 is shown. As illustrated, the example environment includes a computing device 110. The computing device 110 is one of various types of device, including, but not limited to: a tablet computing device, a desktop computer, a mobile communication device, a laptop computer, a laptop/tablet hybrid computing device, a large screen multi-touch display, a gaming device, a smart television, a wearable device, or other type of computing apparatus for executing applications 120 for performing a variety of tasks. The hardware of these computing apparatuses is discussed in greater detail in regard to FIGS. 9, 10A, 10B, and 11.

A user may interact with an application 120 on the computing device 110 for performing a variety of tasks, which include, but are not limited to: writing, calculating, drawing, taking and organizing notes, preparing and organizing presentations, sending and receiving electronic mail, making music, and the like. Applications 120 include thick client applications, which may be stored locally on the computing device 110, and thin client applications (i.e., web applications) that reside on a remote server and are accessible over a network, such as the Internet or an intranet. In various aspects, a thin client application is hosted in a browser-controlled environment or coded in a browser-supported language and is reliant on a web browser to render the application 120 executable on the computing device 110. According to an aspect, the application 120 is a program that is launched and manipulated by an operating system, and manages content 130 within an electronic document 125 and is published on a display screen 115 associated with the computing device 110.

The content 130 in an electronic document 125 will vary according to the application 120 used to provide the electronic document 125. The content 130 may comprise one or more objects present or imbedded in the electronic document 125 including, but not limited to: text (including text containers), numeric data, macros, images, movies, sound files, and metadata. According to one example, the content 130 includes a plurality of digital strokes, sometimes referred to herein as “inking” input, wherein a stroke is a data object that is collected from a pointing device, such as a tablet pen, a finger, or a mouse via freehand input. In various aspects, a stroke is created and manipulated programmatically, and is represented visually on an ink-enabled element, such as an ink canvas of an application 120. In some examples, a stroke contains information about both its position and appearance. In other aspects, freehand input includes using a line tool used to form a shape or object from constituent lines or individual stencils to form a more complex shape (e.g., a triangle stencil and a rectangle stencil to form an arrow shape, multiple rectangle stencils to form a grid).

In various aspects, the data comprising the content 130 are stored in an elemental form by the electronic document 125, such as in Extensible Markup Language (XML) or Java Script Object Notation (JSON) elements or another declaratory language interpretable by a schema. The schema may define sections of content items via tags and may apply various properties to content items via direct assignment or hierarchical inheritance. For example, an object comprising text may have its typeface defined in its element definition (e.g., “<text typeface=garamond>example text</text>”) or the typeface may be defined by a stylesheet or an element above the object in the document's hierarchy from which the element depends.

With reference still to FIG. 1, an application 120 includes or is in communication with a freehand transformer 150, operable to provide the intelligent detection and manipulation of objects via freehand input in the application 120. In one example, the computing device 110 includes a freehand transformation application programming interface (API), operative to enable the application 120 to employ the systems and methods of the present disclosure via stored instructions.

According to aspects, the freehand transformer 150 includes: a gesture recognizer 160; an object converter 170; and a model manipulator 180. The components of the freehand transformer 150 are illustrative of software modules, systems, or devices operative to receive freehand input and manipulate objects within the content 130 of an electronic document 125 based on the freehand input. According to aspects, the freehand input includes a physical act or motion performed on or by an input device 140 (e.g., finger, pen/stylus, mouse) at a position of a user-controlled cursor (such as a mouse cursor or touch-point on a touch-screen interface) that is interpreted by the application 120 as a stroke or other gesture to apply to the content 130 of an electronic document 125. The freehand input includes “inking” input to add strokes for the electronic document 125 as well as gestures that are interpretable based on their shape, speed, pressure, number of inputs (e.g., one finger, two fingers, etc.), and relative position to existing content 130. According to an example, the input device 140 is a pointing device used to specify a position (e.g., x, y coordinates) on a graphical user interface (GUI), and manipulate on-screen objects.

According to one aspect, the gesture recognizer 160 is operable to receive freehand input indicative of an object being selected, for example, via a tap, double-tap, or hover. According to another aspect, the gesture recognizer 160 is operable to receive freehand input indicative of manipulation of an object, such as, for example, selection and movement of a vertex, the addition, modification, or removal of a constraint, and commands to perform affine transformations on the object (move/translate, scale, reflect, rotate, etc.). In one example, the gesture recognizer 160 identifies the position of the user-controlled cursor (e.g., mouse cursor or touch-point) and the relative positions of objects and portions thereof (e.g., an edge, a center point, a vertex, a grippy or manipulation handle) to determine how the freehand input is to be applied within the electronic document 125.

According to an aspect, the object converter 170 is illustrative of a software module, system, or device operative to convert various freehand inputs into strokes that are part of the object or are to be used as property inputs for the object, or convert those gestures into standardized indicators for display with the object. For example, when a user is interacting with an object of a triangle in the electronic document 125 and provides strokes that are interpreted by the gesture recognizer 160 as comprising a right-angle indicator (i.e., forming a quadrilateral at a vertex by adding two additional strokes), the object converter 170 converts those strokes into a feature of the triangle object; removing them as individual objects from the DOM and adjusting the object to include a 90° angle at the given vertex. In another example, the object converter 170 converts gestures interpreted as providing numeric values (e.g., hand-written numerals) for a feature of a target object into numeric values interpretable by the DOM and displayed in a system typeface rather than as hand-written freehand objects. In yet another example, when tick marks are added by freehand input to one or more strokes or vertices of the object to indicate congruence with another stroke or vertex, the object converter 170 is operable to standardize the length and positioning of those marks for an evenly sized and located display of the congruence marks.

The model manipulator 180 is illustrative of a software module, system, or device operative to update the DOM of the electronic document 125 based on the freehand input applied to an object in the content 130. In a first example, when the freehand input indicates that the features' information is to be displayed, the model manipulator 180 is operable to change a visibility setting associated with the features' information in the DOM to make it visible to a user. In a second example, when the freehand input indicates that a feature is to be set at a given value, the model manipulator 180 is operable to set a value for one or more values of the object in its definition in the DOM (e.g., adjust the positions of the vertexes of the object). In a third example, when the freehand input indicates that a position of a vertex is to be changed, the model manipulator 180 is operable to set a value for the vertex in the DOM. In various aspects, the model manipulator 180 is operable to ignore freehand inputs (or portions thereof) that would cause the object to violate a given constraint (e.g., a user-set constraint to a given feature) or to indicate that a given constraint that is to be violated is no longer locked as a constraint (e.g., changing an appearance of a feature indicator to indicate that it is no longer a constraint).

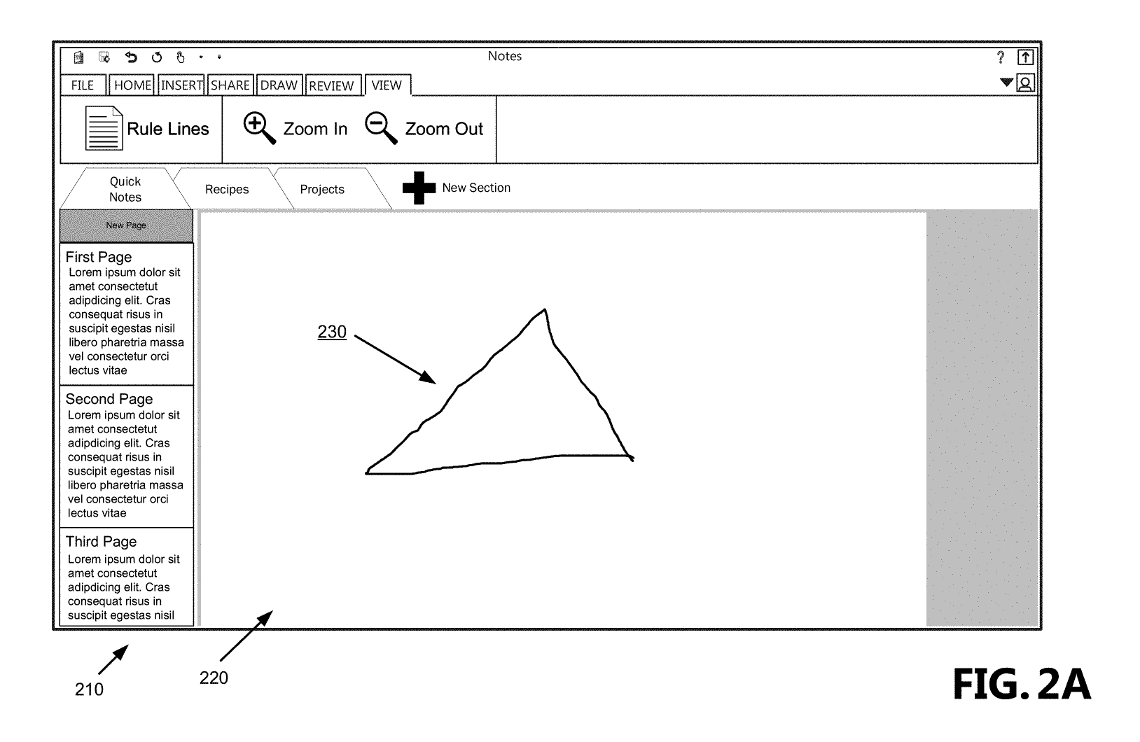

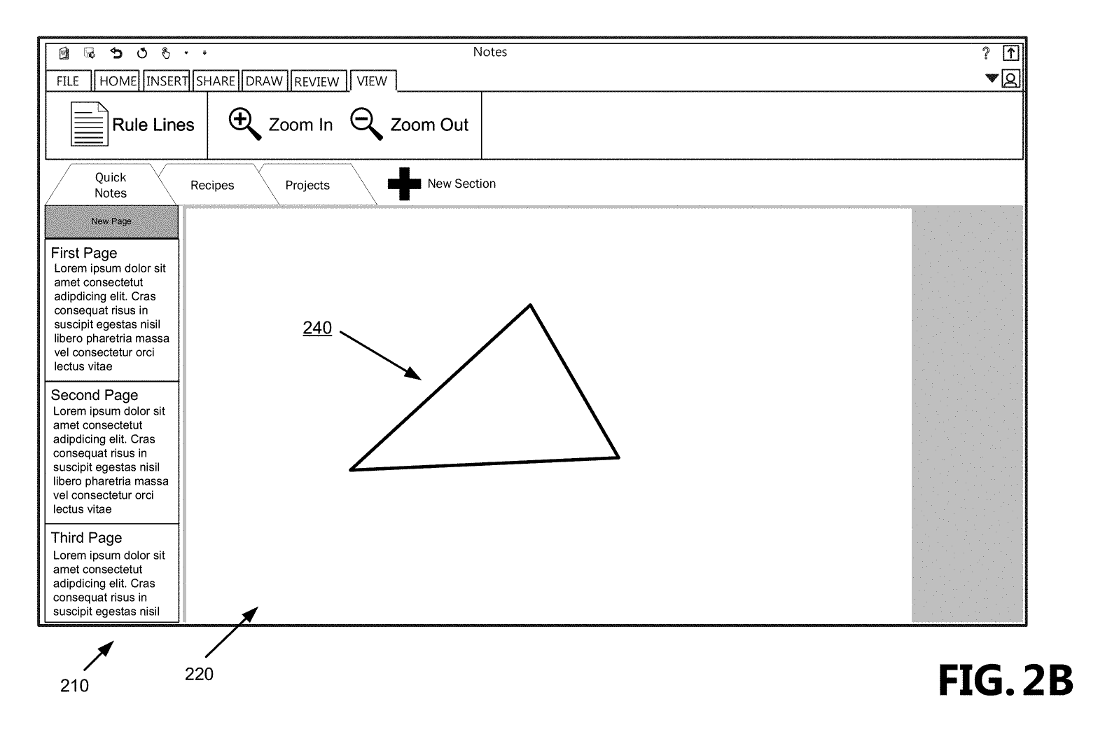

Several various example scenarios of the determination and manipulation of a object via freehand input are provided in relation to FIGS. 2A-7B. FIGS. 2A-7B show various example GUIs (graphical user interfaces) 210 for a note taking application including a canvas 220 in which content 130 is authored via freehand input that illustrate various features and aspects of freehand input determination and manipulation of objects and their features. The canvas 220 accepts freehand input via an input device 140 to produce one or more stroke inputs 230 that are recognized by the freehand transformer 150 to produce objects and gestures in the electronic document 125. These stroke inputs 230 are interpreted as various objects, such as incorporated objects 240 that are incorporated into the DOM of the electronic document 125 and are presented with the values of various features shown by feature markers 250 in the electronic document 125, and (optionally) grippies 245 by which the incorporated object 240 may be manipulated. In various aspects, the one or more features are constrained from changing as the user applies freehand input to the associated incorporated object 240 and are shown as constrained features via constraint markers 260. As will be appreciated, the examples illustrated in FIGS. 2A-7B are non-limiting illustrations; other GUIs from other application types with different elements and arrangements thereof may be used in conjunction with the present disclosure.

FIGS. 2A and 2B illustrate the detection of an object entered via freehand input. In various aspects, objects are entered via means other than freehand input and the freehand transformer 150 is operable to manipulate the object via freehand input and display the features of that object for viewing or manipulation by a user. For example, an object may be detected in an image or document, inserted from another document, or created via a stencil. The freehand transformer 150 is operable to recognize objects from stroke inputs 230 entered into the canvas 220, as is shown in FIG. 2A, and to convert those stroke inputs 230 into a structured object for insertion into the DOM of the electronic document 125. Although examples are given primarily in respect to triangles, other shapes such as arcs, circles, closed and open polygons, etc., are recognizable by the freehand transformer 150 for inclusion in the DOM. As illustrated in FIG. 2B, the incorporated object 240 replaces the original input by which the shape was detected in the canvas 220, but in various aspects, the incorporated object 240 inherits properties of the original input in addition to the positional properties of the stroke inputs 230 (or other inputs) used to detect the shape. Examples of inheritable properties include, but are not limited to: line color, line weight, line dashing, line patterns, fill colors, fill patterns, and other effects. In various aspects, the position of the incorporated object 240 is determined based on the start and end positions of the strokes comprising the freehand object or the vertices where one or more strokes come together, and the freehand transformer 150 creates segments between those vertices as vector lines, thus storing the incorporated object 240 as a vector object (as opposed to a raster object).

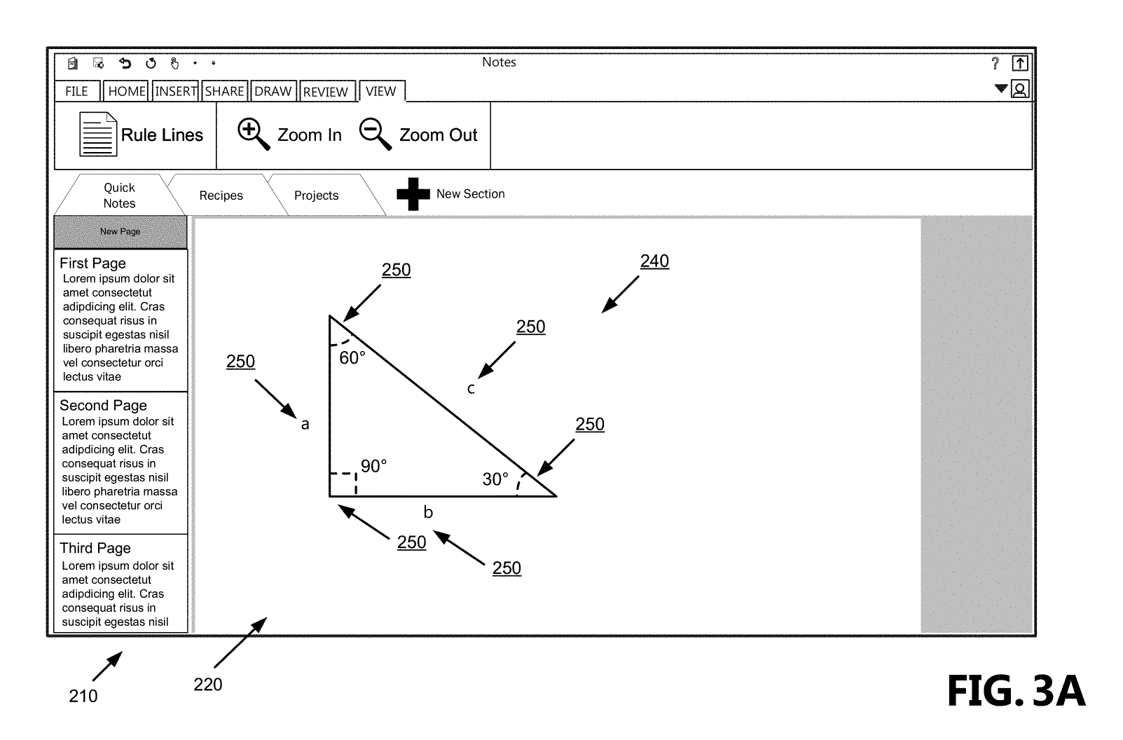

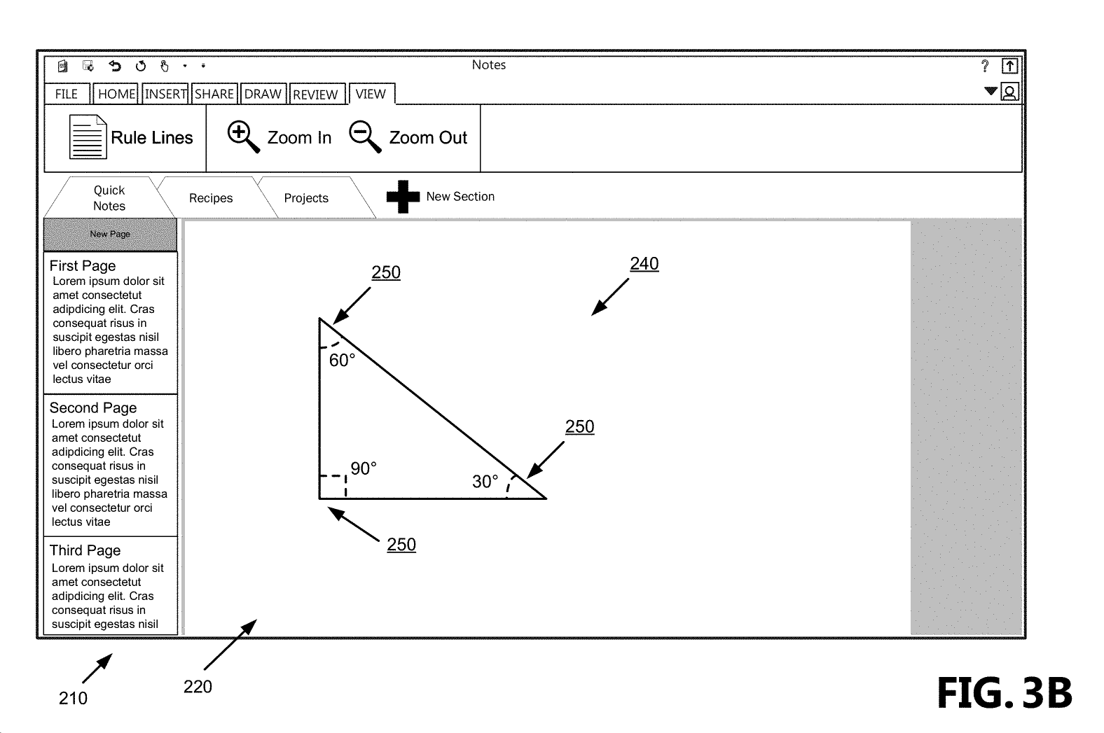

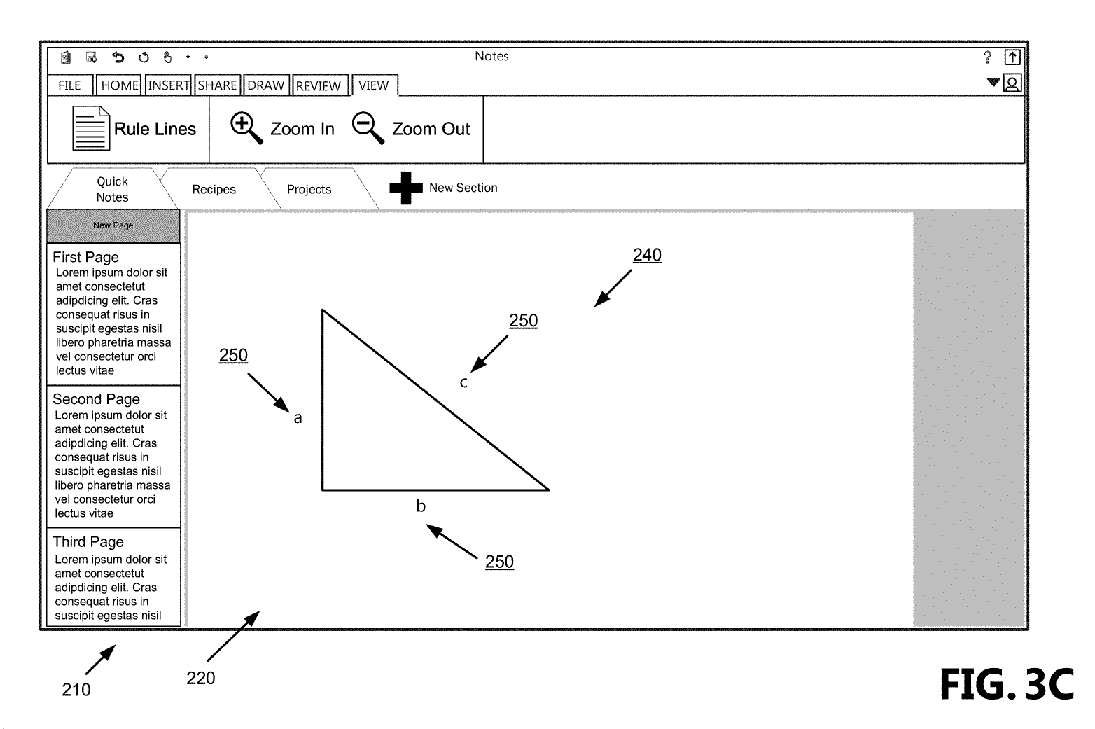

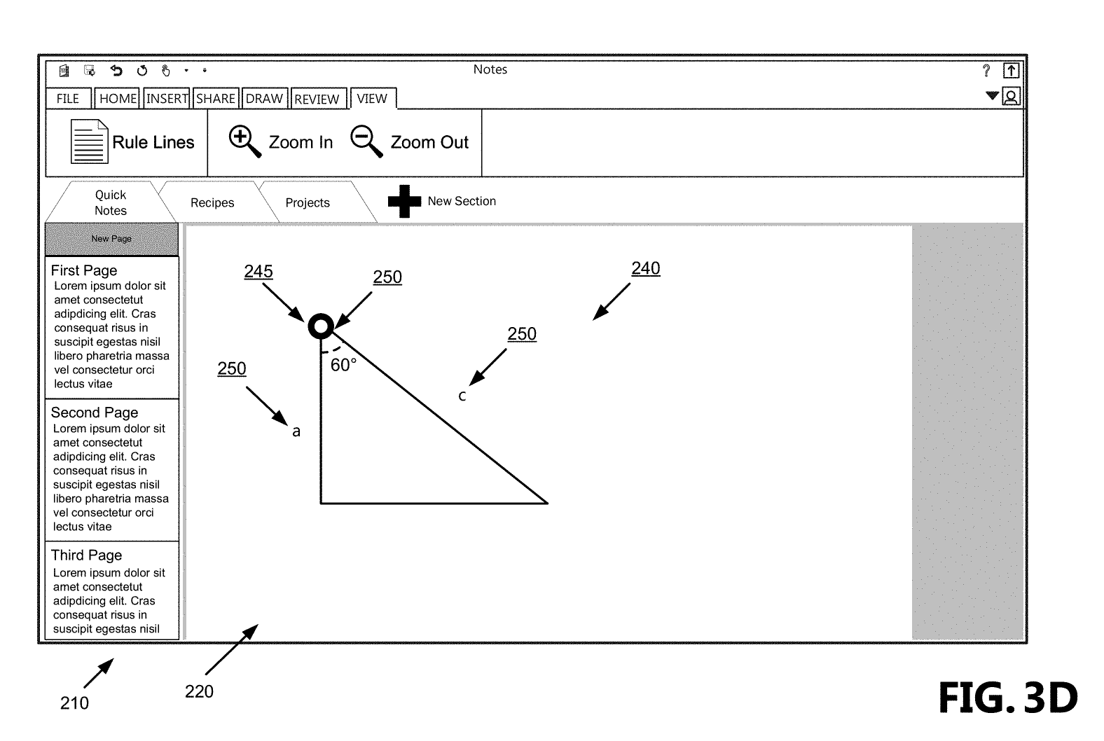

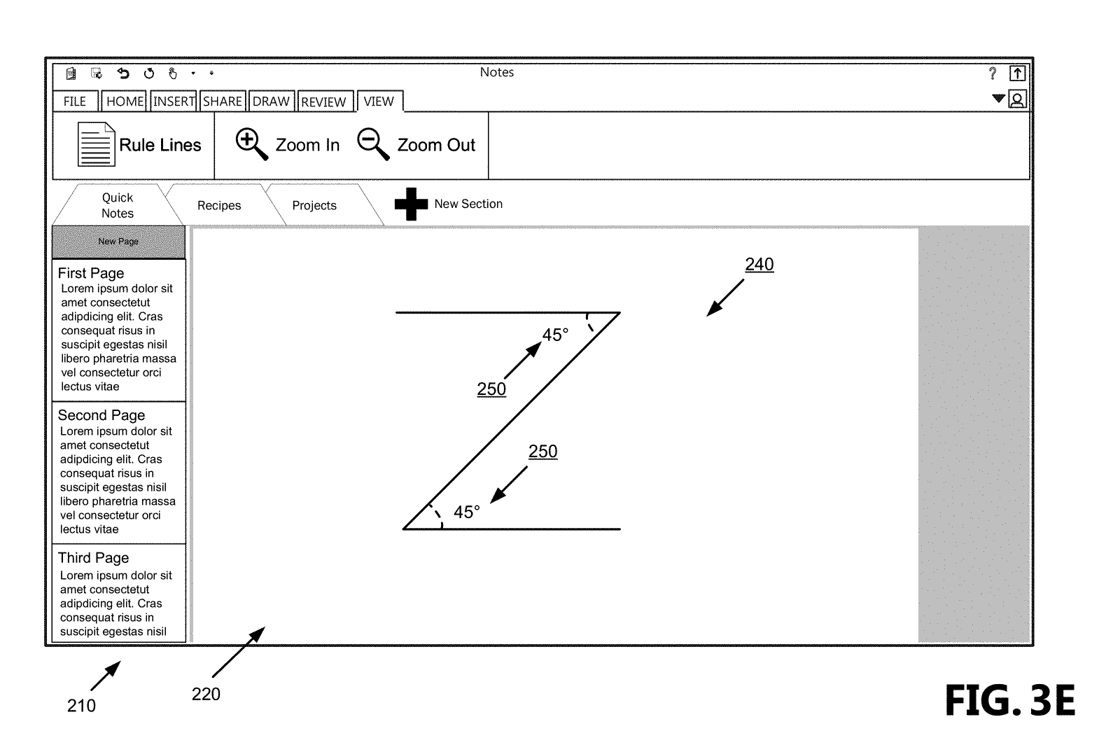

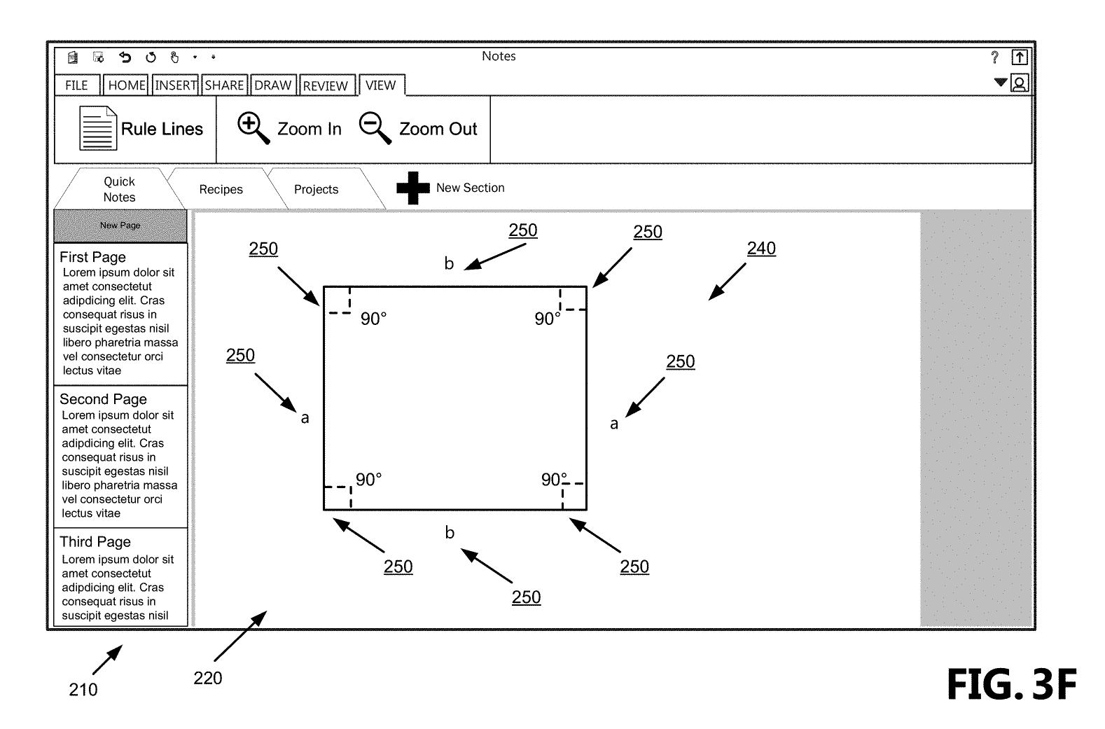

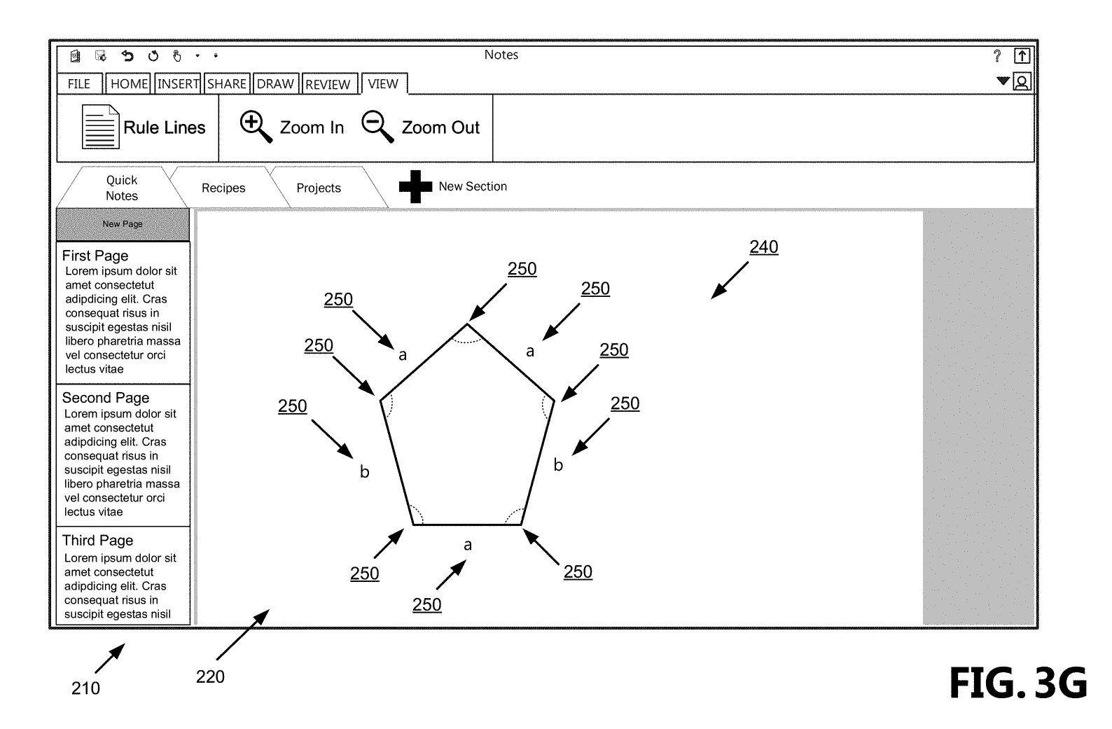

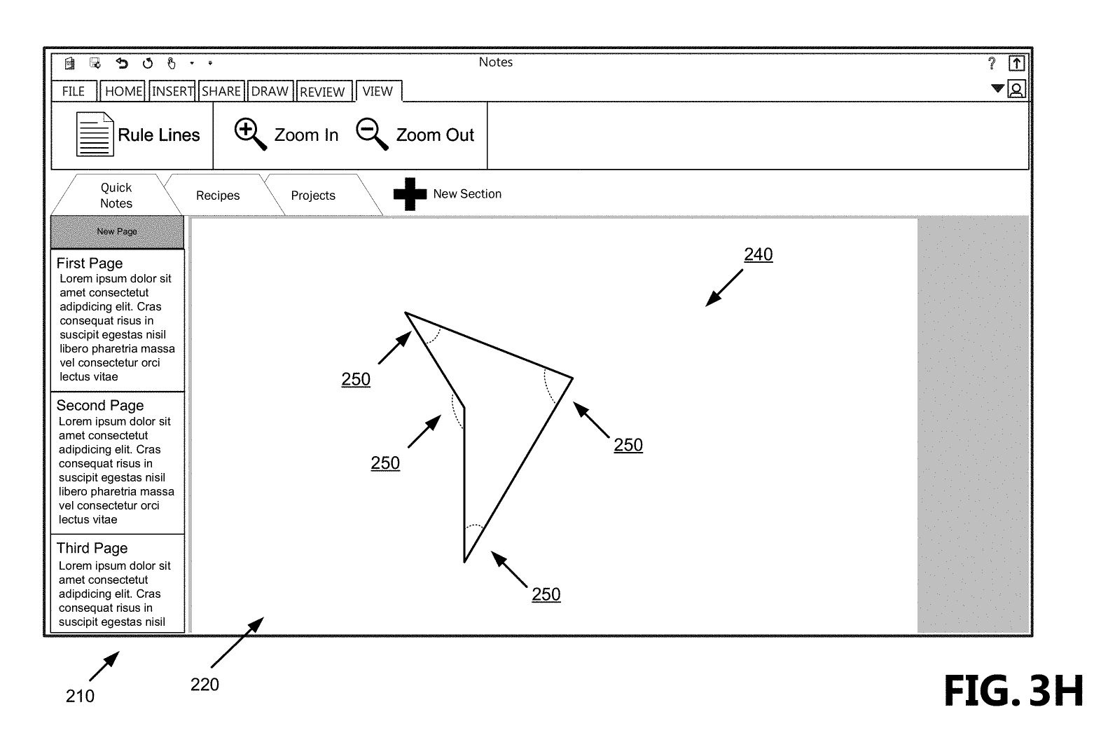

FIGS. 3A-3G illustrate the display of various features in relation to an associated object. The features are calculated by the freehand transformer 150 based on the stored vector object, and are displayed in response to user requests for displaying those features. Where the feature markers 250 are displayed relative to the incorporated object 240 depends on the font size and line thickness of the feature markers 250 (if applicable), the free and unoccupied space in and around the incorporated object 240, and user preferences. In FIG. 3A, each stroke of the incorporated object 240 and the angle between each pair of strokes is displayed by an associated feature marker 250, which displays that value of that feature in the electronic document 125. In FIGS. 3B and 3C, respectively, only the feature markers 250 for angles and stroke lengths are shown, and in FIG. 3D only the feature markers 250 for stroke lengths and angles associated with a given vertex are shown. As will be appreciated, a user may select various combinations of feature markers 250 to display, and set various triggers for their display or dismissal.

In FIG. 3D a grippy 245 is illustrated to indicate that a user has selected the given vertex, but in various aspects grippies 245 may be provided with more than one vertex, a center point of the object, edges of the object or a point of rotation for the object to aid in the user applying freehand input to manipulate the object.

As will be appreciated, the freehand transformer 150 is operable to identify and provide feature markers 250 for a variety of shapes in addition to those shown here. As is illustrated in FIG. 3E, the shapes include open polygons and line segments as well as the closed polygons discussed in the other figures. As is shown in FIGS. 3F and 3G, illustrating a quadrilateral and a pentagon respectively, the object may be any one of a variety of closed polygons, which may be regular or irregular. As is shown in FIG. 3H, illustrating a quadrilateral, the object may include inward protrusions, which may be associated with feature markers 250 internal or external to the object. One of ordinary skill in the art will appreciate that the present disclosure is applicable to a wide variety of objects, which come in myriad arrangements.

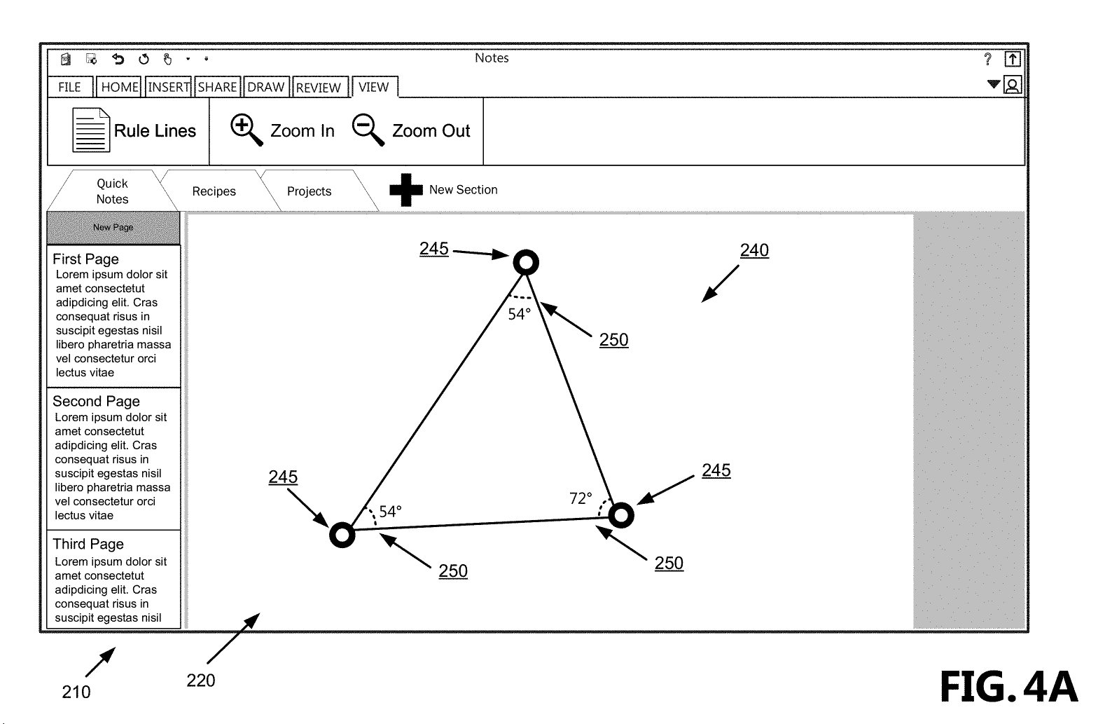

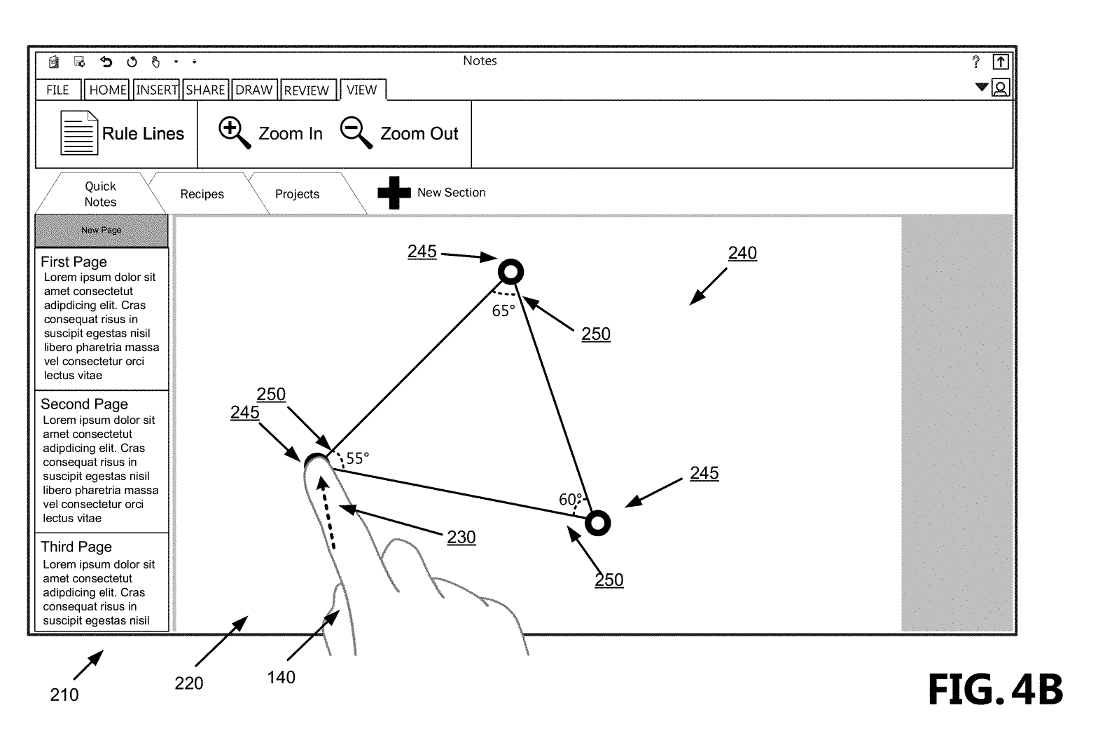

FIGS. 4A and 4B illustrate manipulation of an object via freehand input. FIG. 4A illustrates an initial state of an incorporated object 240 of a triangle, grippies 245 at each of its vertices, and feature markers 250 for the initial angles for each of its vertices. FIG. 4B illustrates a progression from FIG. 4A, where a user makes a stroke input 230 via an input device 140 (e.g., a finger on a touchscreen) that selects and moves the vertex associated with a selected grippy 245 to a new location on the canvas 220. The freehand transformer 150 updates the DOM with the new position of the moved vertex of the incorporated object 240 and updates the values displayed in the feature markers 250 to reflect the updated state of the incorporated object 240.

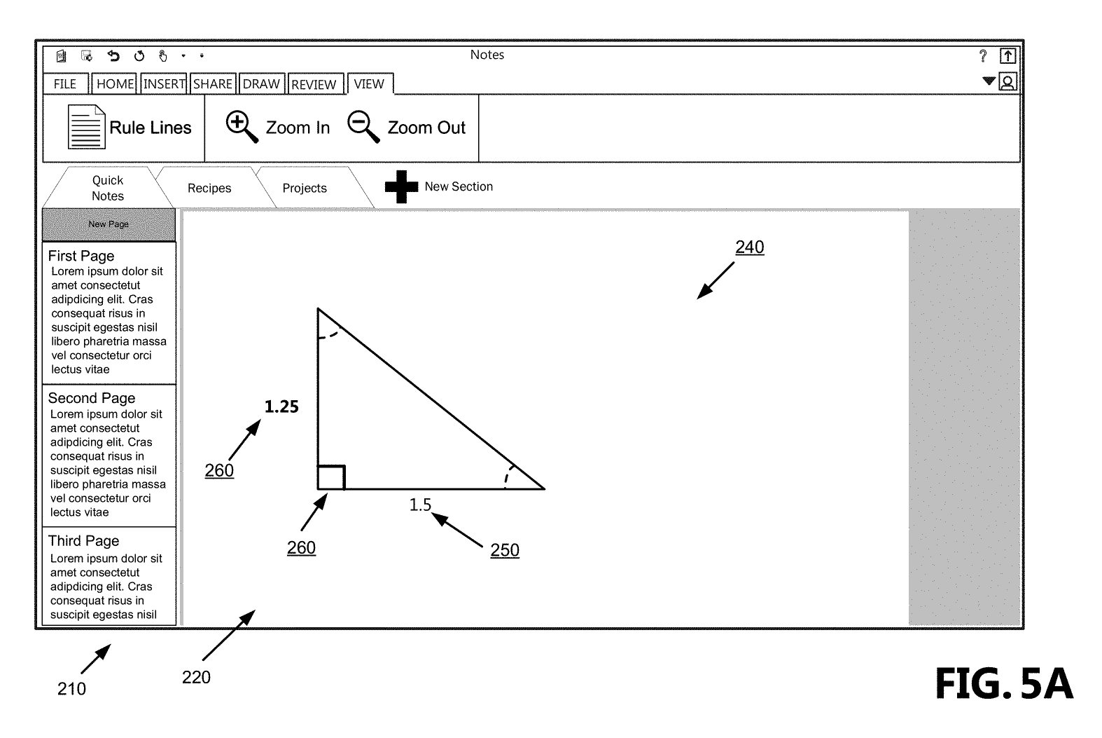

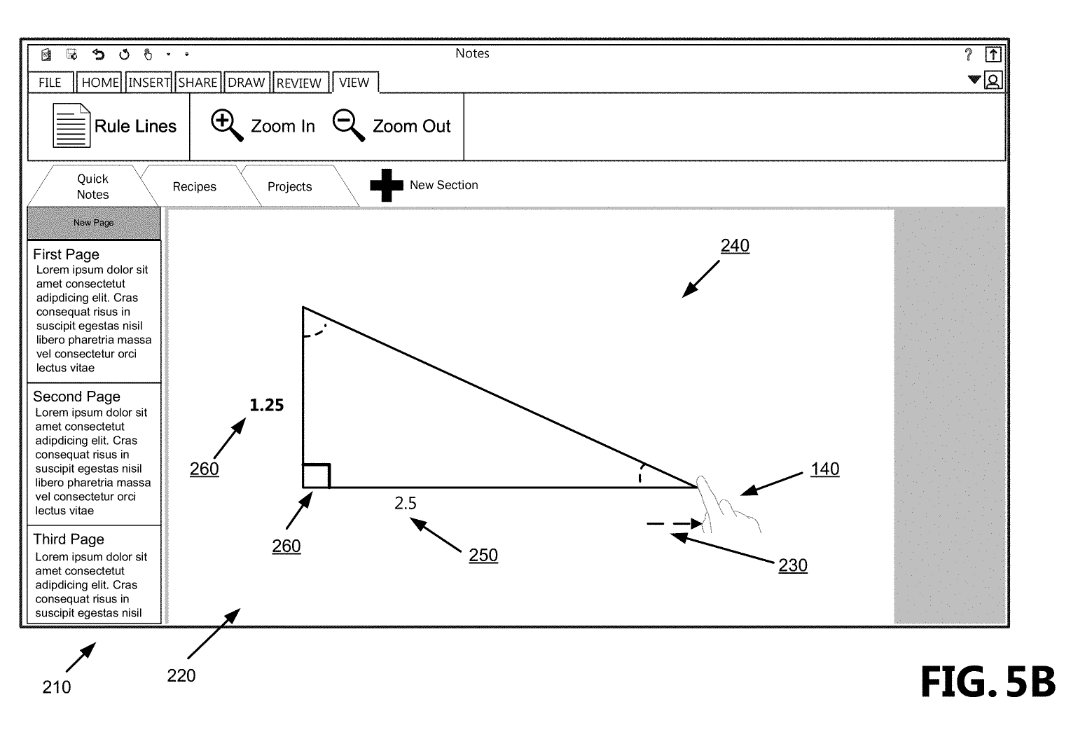

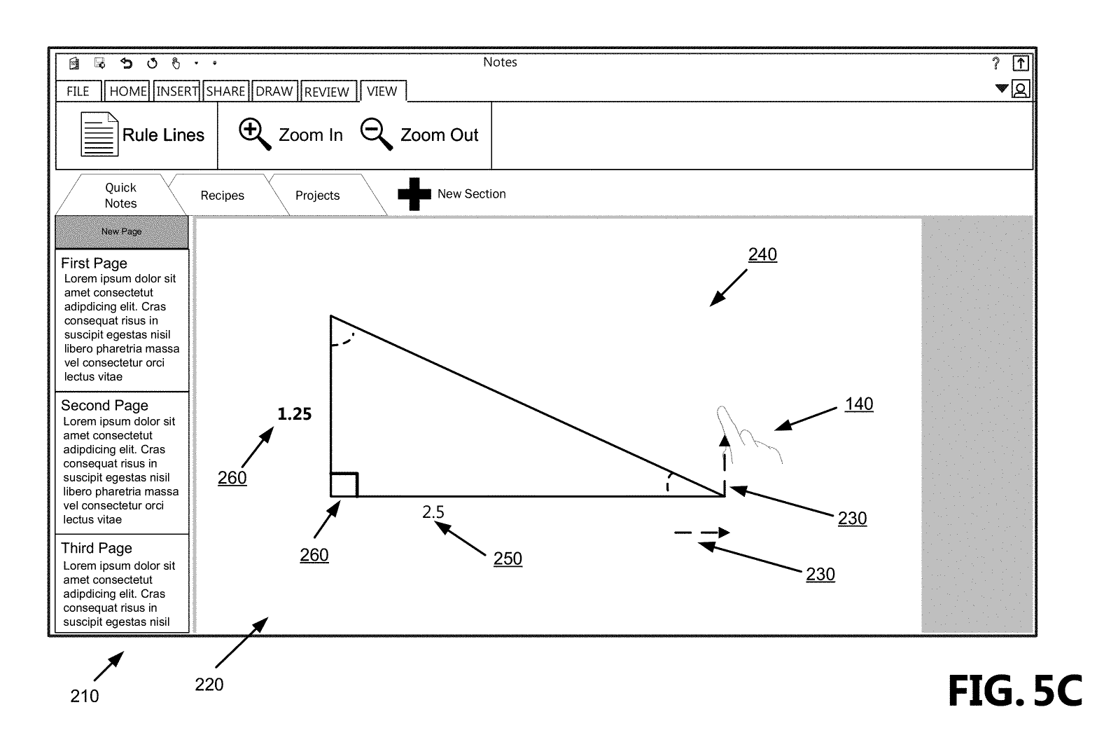

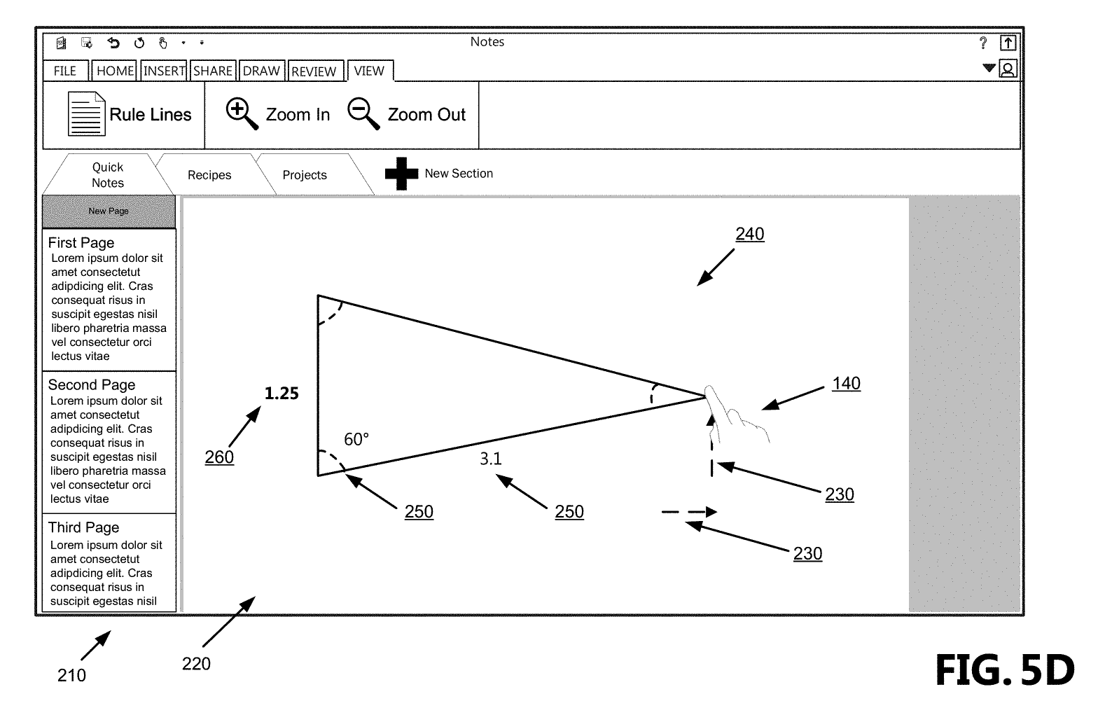

FIGS. 5A-5D illustrate the manipulation of an object that has one or more features constrained. Constraint markers 260 are displayed with features whose values are to be displayed. Constraint markers 260 are similar to feature markers 250 in that the value (numeric or relative) of a given feature is displayed, but the constraint markers 260 serve to alert the user that a given feature is bound in its value to the value of another feature (relative constraints) or to an absolute value (numeric constraints). Constraint markers 260, in various aspects, are standardized in size (relative to the object they are displayed with), and may be shown as symbolic and/or numeric values having different display properties than feature markers 250 (e.g., darker, bolder, in a unique color). As illustrated in FIG. 5A, the right angle of the triangle is shown with a bolder appearance than the other angle markers, and is a constraint marker 260, showing that the angle will not change as the user manipulates various properties of the incorporated object 240. Similarly, the vertical stroke of the triangle is shown with a bolder appearance than the feature marker 250 for the horizontal stroke of the triangle, indicating that the length value of the vertical stroke is constrained (in the illustrated example to 1.25 units).

FIG. 5B illustrates a first potential progression from FIG. 5A in which a user has manipulated the incorporated object 240 via a horizontal stroke input 230 from an input device 140 to extend the length of the horizontal stroke of the triangle (to 2.5 units from 1.5 units in the illustrated example). Because the length of the horizontal stroke can be changed in the horizontal direction without needing to alter the constrained right angle or the constrained length of the vertical side, the user is enabled to use freehand input to modify the size of the incorporated object 240. As illustrated, the feature marker 250 for the horizontal stroke is updated to reflect its new length value.

FIG. 5C illustrates a second potential progression from FIG. 5A in which a user has manipulated the incorporated object 240 via a stroke input 230 (via an input device 140) with horizontal and vertical elements to the stroke input 230. Because the right angle is constrained to remain a right angle, the vertical component of the stroke input 230 is ignored so that the angle value does not change. For example, the vertical component of the stroke input 230 may have been inadvertent (user or hardware error on a touch surface) and a user may desire to keep the incorporated object 240 a right triangle and ignore the vertical component that would violate the constraint. In various aspects, the incorporated object 240 may rotate to accommodate the vertical component of the stroke input 230 without violating the constraint on the angle. In other aspects, a constraint is removed from a feature to allow a manipulation to incorporate the component(s) that would otherwise violate a constraint.

FIG. 5D illustrates a third potential progression from FIG. 5A in which a user has manipulated the incorporated object 240 via a stroke input 230 (via an input device 140) with horizontal and vertical elements to the stroke input 230, and a constraint is removed to accommodate the stroke input 230. In various aspects, when a constraint is removed from a feature, an alert is provided to the user to indicate that one or more constraints are to be removed. In various aspects, the alert is a dialog that a user must accept (or choose which constraint(s) is removed), while in other aspects, the alert is a GUI feature, such as, for example, a feature flashing when it is no longer constrained or the constraint marker 260 (and its appearance) changing to a feature marker 250. The freehand transformer 150 is operable, in various aspects, to preserve constraints in a hierarchical fashion (e.g., based on the age of a constraint, user-assigned weight, complexity, number of features sharing or affected by the constraint). As is illustrated, the constraint on the right angle has been removed (allowing the angle to reduce to 60° in the illustrated example to accommodate the vertical component of the stroke input 230), but the constraint of the length of the vertical stroke, which is unaffected by the illustrated manipulation, remains locked.

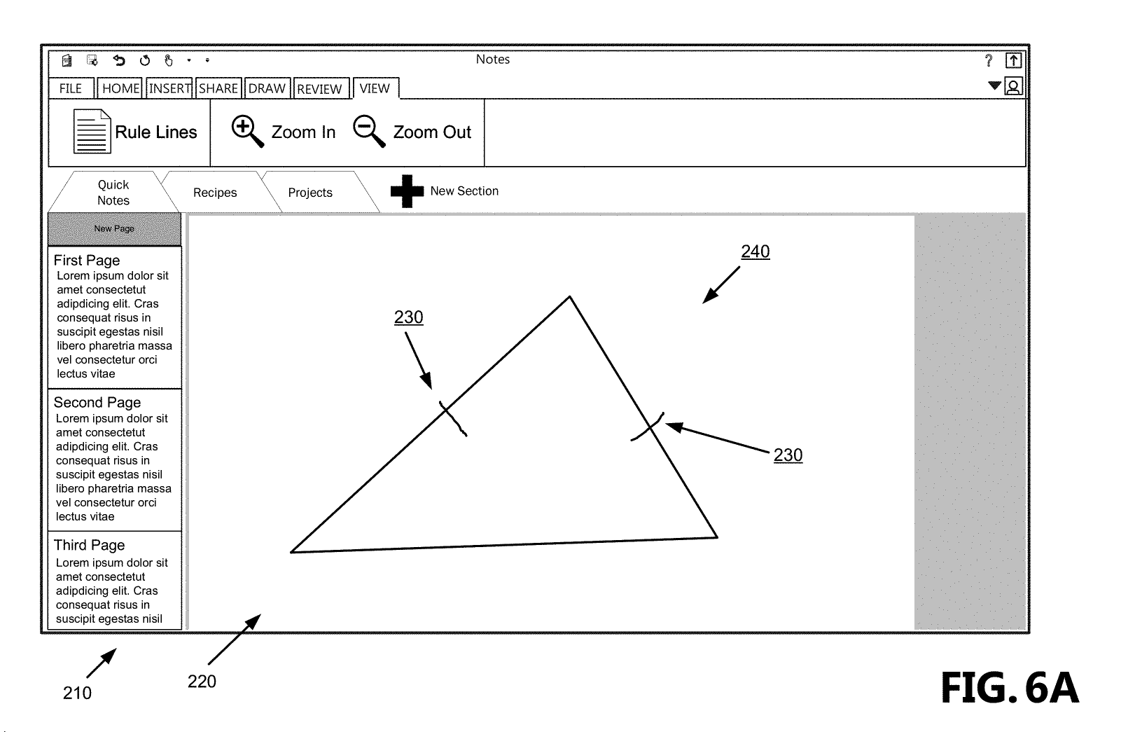

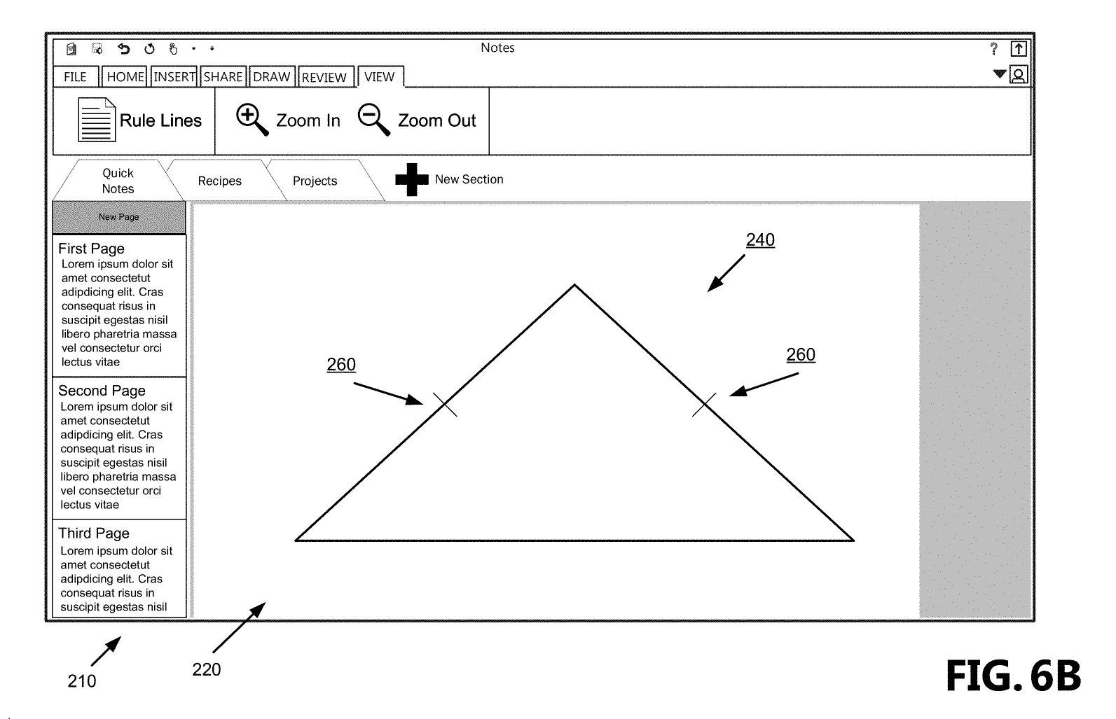

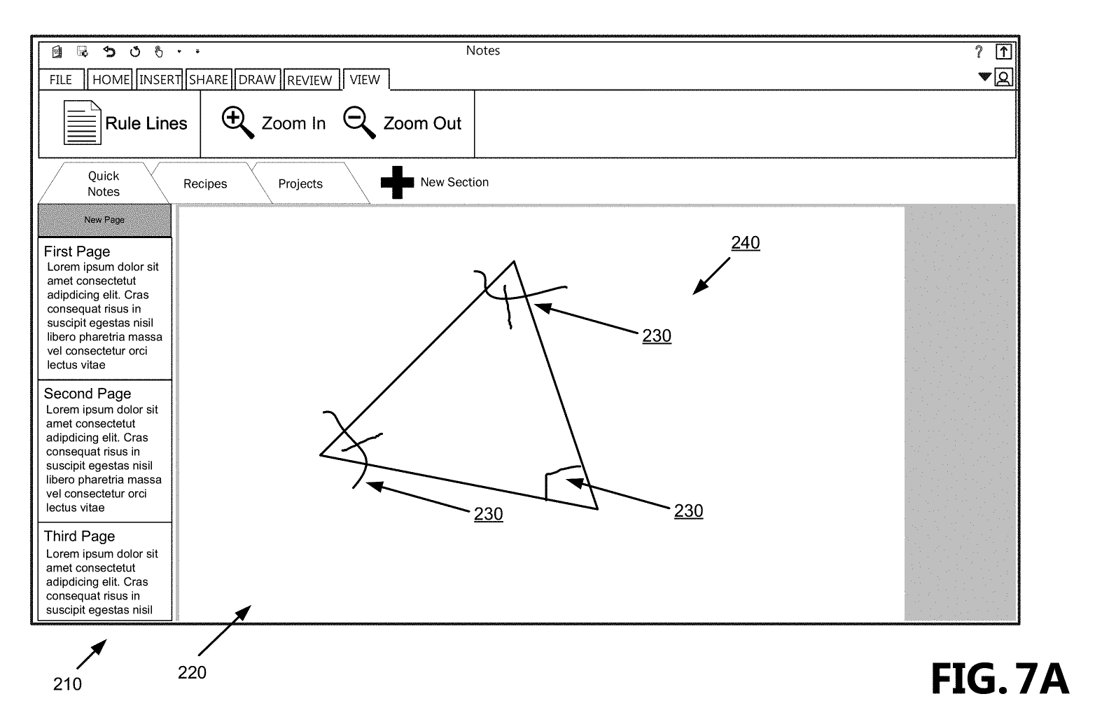

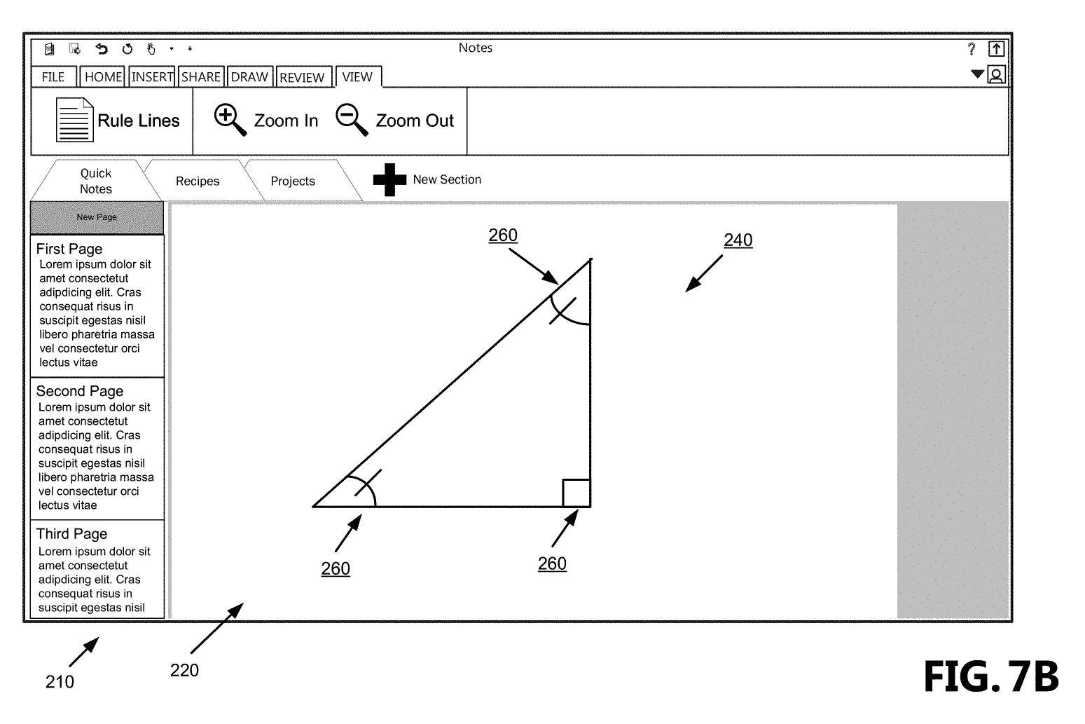

FIGS. 6A and 6B illustrate the input of constraints on stroke lengths and FIGS. 7A and 7B illustrate the input of constraints on angles of a shape. As will be appreciated, constraints may be applied to various objects symbolically (e.g., via tick marks showing equivalence or difference between two features of one or more objects) as well as numerically (e.g., setting fixed value for a given feature), and the examples given in FIGS. 6A-7B are provided as non-limiting examples of how a feature may be constrained. In various aspects, two or more strokes (or objects) may be constrained to be parallel, perpendicular, congruent, geometrically similar, etc.

As shown in FIG. 6A, a user has made stroke inputs 230 to apply tick marks to two strokes of an incorporated object 240. The freeform transformer 150 is operable to recognize that tick marks are used in geometry to symbolically indicate that two or more segments with the same number of tick marks are constrained to be the same length. The freeform transformer 150 thereby recognizes the two strokes to be constrained, and as illustrated in FIG. 6B, applies the constraint so that both strokes are the same length. The incorporated object 240 is also displayed in association with constraint markers 260 indicating that the two sides of the incorporated object 240 are constrained to being the same length.

As shown in FIG. 7A, a user has made stroke inputs 230 to apply tick marks to two angles of an incorporated object 240 and a right-angle bracket to the remaining angle. The freeform transformer 150 is operable to recognize that tick marks are used in geometry to symbolically indicate that two or more angles with the same number of tick marks are constrained to be the same arc-length (i.e., displayed angle value). The freeform transformer 150 is further operable to recognize that right-angle brackets (i.e., a quadrilateral in a vertex) are used in geometry to symbolically indicate that a given angle is constrained to being set to 90° (i.e., a right angle). The freeform transformer 150 thereby recognizes the three angles to be constrained, and as illustrated in FIG. 7B, applies the constraints so that both stroked angles are the same angle (45° in the present example), and the bracketed angle is a right angle. The incorporated object 240 is also displayed in association with constraint markers 260 indicating that the angles of the incorporated object 240 are constrained in their values.

Although FIGS. 6A-7B are shown in black and white and with straight tick marks, in various aspects different colors and different shapes may be applied to impart various constraints. In one aspect, tick marks of the same color are grouped together to apply a given effect (e.g., congruent lengths/angles) so that users do not have to apply multiple tick marks to distinguish two or more sets of strokes/angles to have a constraint placed thereon. For example, instead of applying one tick mark to a first and a second angle to indicate that they are to share a first value and two tick marks on a third and fourth angle to indicate that they are to share a (different) second value, one tick mark is applied to the third and fourth angles with a different color from the tick mark applied to the first and second angles. In another aspect, more complex strokes from simple ticks are recognized to apply congruence or specialized behavior. In a first example, the stroke applied to the first and second angles discussed above (e.g., one tick) may differ from a stroke applied to the third and fourth angles (e.g., a circle) to differentiate the values of the sets of angles. In a second example, a stroke of a particular geometry/orientation may indicate a relationship other than congruence, such as carets placed on strokes to be indicated as parallel. The benefits of color or geometry-based constraint grouping includes at least given greater confidence and visual cues to the user as well as avoiding prematurely applying a constraint. For example, when receiving a series of tick marks (e.g., two) to indicate that an angle or stroke belongs to a second grouping (indicated by two tick marks), the stroke or angle may be erroneously believed to belong to a first grouping (indicated by one tick mark) after a first tick of the two tick marks is input, which is avoided by using distinct colors or shapes.

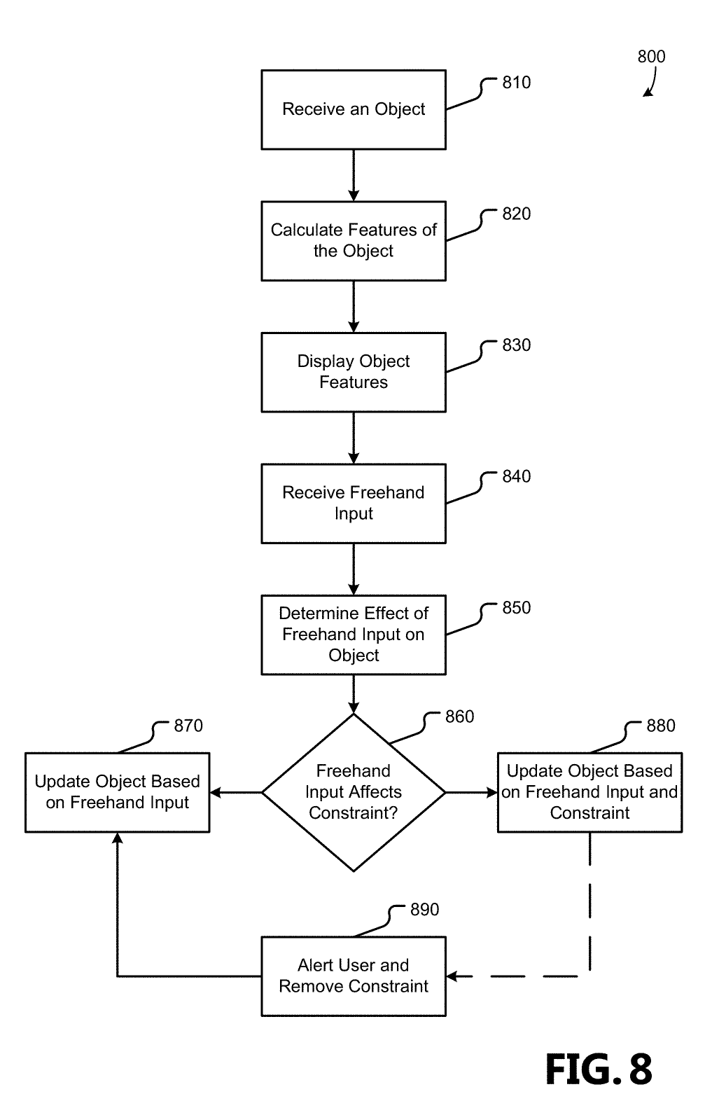

FIG. 8 is a flowchart showing general stages involved in an example method 800 for providing intelligent detection and manipulation of objects via freehand input. Method 800 begins at OPERATION 810 when an object is received in an electronic document 125. The object represents an element of content in the electronic document 125 that includes one or more strokes that start and end at points in the electronic document 125 having various positional values (e.g., Cartesian coordinates). As used herein, when two strokes share a given start or end point, that point is referred to as a vertex, from which angles between the two strokes are defined.

In various aspects, the object is received as freehand input (e.g., a user drawing a shape), received as input via a stencil or other tool, is pasted from another electronic document 125, or is recognized as a sub-object of a parent object. In aspects where the object is received via freehand input, the freehand transformer 150 is operable to convert the freehand object into a recognized object (e.g., a polygon with a corresponding number of strokes) so that the strokes and the angles between strokes are smoothed. When smoothed, strokes are straightened and/or aligned with other strokes in the electronic document 125 and angles are adjusted to conform with object definitions (e.g., no more than 180° internally to a triangle) and frequently-used values (e.g., 89° is adjusted to 90°, 37.285492° is adjusted to 37° degrees) and any feature markers are updated accordingly. Additionally, open polygons whose defining segments are within a threshold distance may be automatically closed—having one or more segments lengthened or shortened to meet at a vertex or an angle adjusted to for a vertex.

As will be appreciated, when adjusting lengths of strokes and/or angles according to an object definition, one or more features of the object may be designated to collect rounding errors. For example, if it is determined that a given polygon is approximately regular, one stroke's length or one vertex's angle will be a different value than the other lengths or angles to account for the differences (e.g., rounding errors) that prevent the polygon from being regular.

The features of the object are calculated at OPERATION 820. The calculated features include the length of the strokes comprising the object, the angles of the object's vertices, whether two strokes are perpendicular, whether two strokes are parallel (e.g., via arrow marks on the strokes), whether a portion of the object is congruent to another portion of the object, what units to use (e.g., inches, millimeters, pixels, radians, degrees), among other features. As will be appreciated, the angle between two strokes in a closed polygon define two angles—an interior angle and an exterior angle—whose sum is 360° (or 2π radians), of which one or both may be calculated as features.

Proceeding to OPERATION 830, one or more of the features of the object are displayed. In various aspects, the features are displayed in response to a freehand input being applied to the object, such as, for example, a user hovering over or selecting the object. The displayed features may be set by the user to remain displayed when an interaction is removed from the object or to revert to a non-displayed state when the interaction is removed. Similarly, a user is enabled to set whether the features are to be included in a published version of the electronic document 125 (e.g., whether the features are visible to coauthors or on a printout of the electronic document 125). The features displayed may include all or a subset of the features of the object (the lengths of strokes, the angles of vertexes, congruencies of strokes, congruencies of angles, etc.) and the user may set, according to preferences, how the features are to be displayed relative to the object.

In various aspects, the features are displayed with a different color, line weight, or line dashing than the strokes of the object to indicate that they are not part of the object, but are related to the object. For example, the arc of an angle is displayed as a dashed line with a lower contrast than the strokes defining the angle (i.e., grayed out).

In aspects where a given feature is set as a constraint, so that it remains the same as the user interacts with the object (or the user is alerted when the value of the feature changes), the given feature may be displayed differently than the non-constrained features, such as, for example, with a double stroke effect, greater line weight, a different line dashing, a higher contrast color, etc. For example, when a non-constrained feature is shown with a dashed light gray effect, the constrained feature is displayed with a solid dark gray effect. Features may be set as constrained via freehand input or other user interactions (e.g., via a menu, dialog, or control in a user interface) or may be automatically set as constrained when the object is received.

At OPERATION 840 a freehand input to interact with the object is received. In various aspects, the freehand input is received via a pointing device as “ink” or similar input to perform various modifications to the object, individual features of the object, or feature markers of the object. The freehand input, if received as stroke inputs, may be removed once it is recognized as a gesture to affect the object, may be converted to a standardized format, or removed from display. In a first example, when the freehand input selects the object to rotate the object, the object will be rotated and the freeform input will not be displayed as strokes in the electronic document 125. In a second example, when the freehand input adds tick marks to two or more strokes of the object to indicate that the strokes are constrained as congruent in length, the tick marks are displayed as input by the user. In a third example, when the freehand input adds tick marks to two or more strokes of the object to indicate that the strokes are constrained as congruent in length, the tick marks are adjusted to a standardized size and position on the strokes to indicate their congruence. In a fourth example, when the freehand input adds tick marks to two or more angles of the object to indicate that the angles are constrained as equivalent in arc-length, the tick marks are adjusted to a standard size and position on the angle markers to indicate their equivalent values.

The gesture recognizer 160 determines at OPERATION 850 the effect of the freehand input on the object. The user's intended interaction is determined based on the object; the position of the freehand input relative to the object, portions of the object, and the displayed features of the object; and the relative motions of the freehand input. For example, freehand input proximate to a displayed feature's value may set a value for that feature (e.g., a length, an angle) based on text recognition. In another example, freehand input proximate to a vertex or grippy of the object may be interpreted to indicate that the user wishes to interact by dragging the vertex or grippy to a new position, thus changing the size/shape of the object or its position on the canvas of the electronic document 125.

Proceeding to DECISION 860, it is determined whether the freehand input will affect a constrained feature of the object. In various aspects, the object may contain no constrained features, or a feature that is constrained is not affected by the interaction. For example, an interaction to scale (proportionally or in an unrelated direction), translate, or rotate the image will not impact a constrained angle. When the freehand input does not affect a constraint, method 800 proceeds to OPERATION 870. In cases in which it is determined that the interaction will affect the constraint, method 800 proceeds to OPERATION 880.

At OPERATION 870, the object is updated based on the freehand input to affect one or more aspects of the object. In various aspects, the positions of the points defining the ends of the strokes comprising the object are adjusted in the DOM to affect the interaction indicated by the freehand input. In various aspects, the interactions may “snap” the strokes, vertexes, or angles to various values based on pre-defined frequently used resting values (e.g., n/8 or n/10 unit lengths like 1.125 or 1.2, but not n/9 unit lengths like 1.4444; 15° arc increments; combinations of length and arc segments for round/frequent numbers) or the size or orientation of other strokes/angles or “rulers” defined in the content 130 of the electronic document 125.

At OPERATION 880, the object is updated based on the freehand input in light of the constraint. In various aspects, the positions of the points defining the ends of strokes comprising the object are adjusted in the DOM to affect the interaction as closely as possible without changing the value of the features indicated as constrained. For example, a freehand input to adjust the location of a stroke associated with a vertex having a constrained angle may allow the positional values of the stroke's opposite end to be adjusted in only one direction, thus preserving the constrained angle. In another example, where the freehand input imposes a constraint, the positional values of one or more strokes are adjusted to implement the constraint (setting two or more strokes as congruent or different in length, angles as equivalent or different in arc-length)

In various aspects, method 800 optionally proceeds from OPERATION 880 to OPERATION 890 to alert the user that a constraint is preventing the freehand input from being fully affected on the object and to remove the constraint, with the user's permission, to proceed to OPERATION 870 to fully affect the intended interaction. In various aspects, the user indicates permission by selecting an “approve” option from a dialog (via freehand input or otherwise) or persisting in attempting to implement the interaction. In various aspects, the alert includes a dialog, a flash or other highlighting of the constraints preventing the interaction from full realization.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 9-11 and the associated descriptions provide a discussion of a variety of operating environments in which examples are practiced. However, the devices and systems illustrated and discussed with respect to FIGS. 9-11 are for purposes of example and illustration and are not limiting of a vast number of computing device configurations that are used for practicing aspects, described herein.

FIG. 9 is a block diagram illustrating physical components (i.e., hardware) of a computing device 900 with which examples of the present disclosure may be practiced. In a basic configuration, the computing device 900 includes at least one processing unit 902 and a system memory 904. According to an aspect, depending on the configuration and type of computing device, the system memory 904 comprises, but is not limited to, volatile storage (e.g., random access memory), non-volatile storage (e.g., read-only memory), flash memory, or any combination of such memories. According to an aspect, the system memory 904 includes an operating system 905 and one or more program modules 906 suitable for running software applications 950. According to an aspect, the system memory 904 includes a freehand transformer 150, operable to enable a software application 950 to employ the teachings of the present disclosure via stored instructions. The operating system 905, for example, is suitable for controlling the operation of the computing device 900. Furthermore, aspects are practiced in conjunction with a graphics library, other operating systems, or any other application program, and is not limited to any particular application or system. This basic configuration is illustrated in FIG. 9 by those components within a dashed line 908. According to an aspect, the computing device 900 has additional features or functionality. For example, according to an aspect, the computing device 900 includes additional data storage devices (removable and/or non-removable) such as, for example, magnetic disks, optical disks, or tape. Such additional storage is illustrated in FIG. 9 by a removable storage device 909 and a non-removable storage device 910.

As stated above, according to an aspect, a number of program modules and data files are stored in the system memory 904. While executing on the processing unit 902, the program modules 906 (e.g., freehand transformer 150) perform processes including, but not limited to, one or more of the stages of the method 800 illustrated in FIG. 8. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 900 has one or more input device(s) 912 such as a keyboard, a mouse, a pen, a sound input device, a touch input device, etc. The output device(s) 914 such as a display, speakers, a printer, etc. are also included according to an aspect. The aforementioned devices are examples and others may be used. According to an aspect, the computing device 900 includes one or more communication connections 916 allowing communications with other computing devices 918. Examples of suitable communication connections 916 include, but are not limited to, radio frequency (RF) transmitter, receiver, and/or transceiver circuitry; universal serial bus (USB), parallel, and/or serial ports.

The term computer readable media, as used herein, includes computer storage media apparatuses and articles of manufacture. Computer storage media include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (i.e., memory storage). According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. According to an aspect, any such computer storage media is part of the computing device 900. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

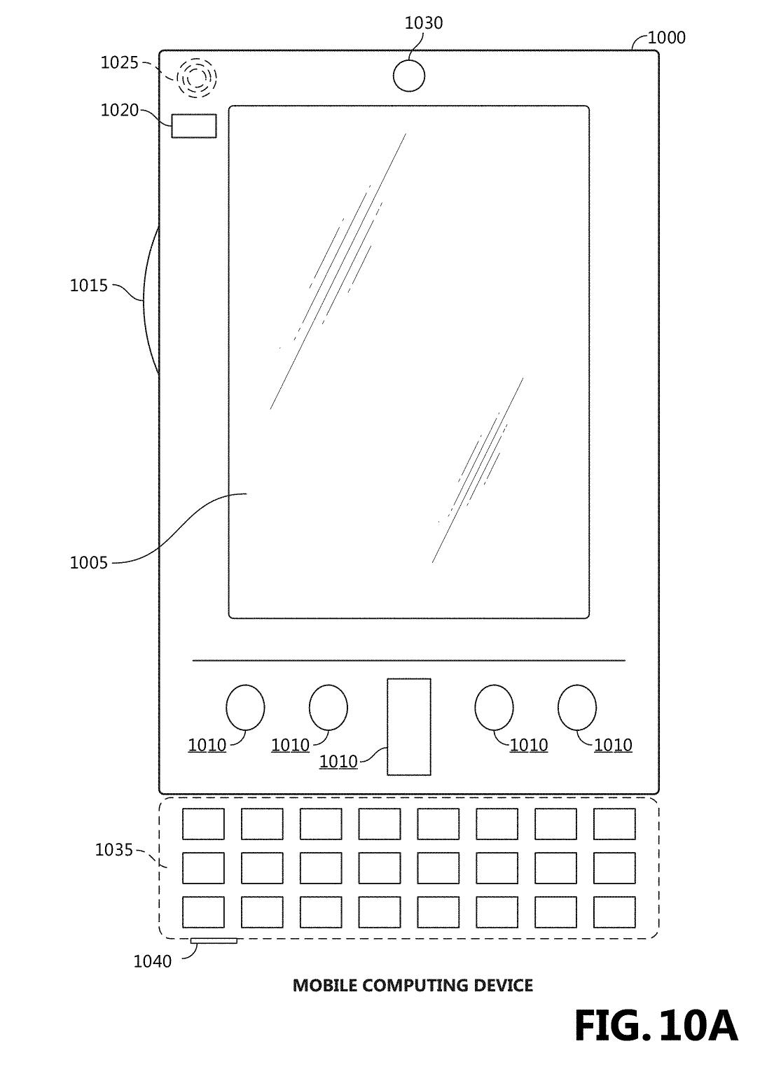

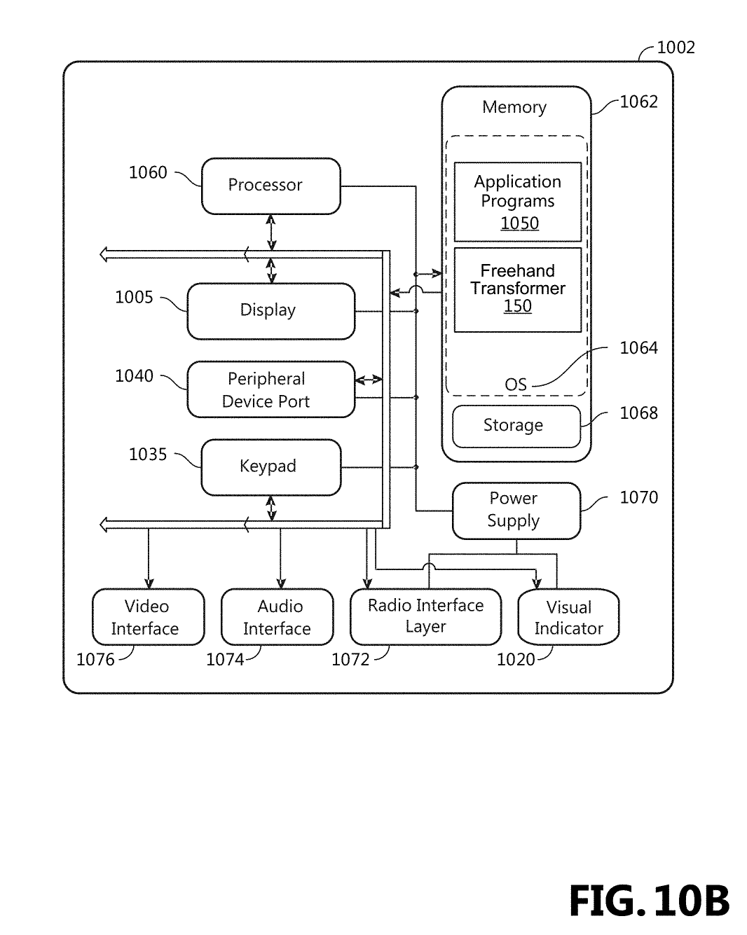

FIGS. 10A and 10B illustrate a mobile computing device 1000, for example, a mobile telephone, a smart phone, a tablet personal computer, a laptop computer, and the like, with which aspects may be practiced. With reference to FIG. 10A, an example of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. According to an aspect, the display 1005 of the mobile computing device 1000 functions as an input device (e.g., a touch screen display). If included, an optional side input element 1015 allows further user input. According to an aspect, the side input element 1015 is a rotary switch, a button, or any other type of manual input element. In alternative examples, mobile computing device 1000 incorporates more or fewer input elements. For example, the display 1005 may not be a touch screen in some examples. In alternative examples, the mobile computing device 1000 is a portable phone system, such as a cellular phone. According to an aspect, the mobile computing device 1000 includes an optional keypad 1035. According to an aspect, the optional keypad 1035 is a physical keypad. According to another aspect, the optional keypad 1035 is a “soft” keypad generated on the touch screen display. In various aspects, the output elements include the display 1005 for showing a graphical user interface (GUI), a visual indicator 1020 (e.g., a light emitting diode), and/or an audio transducer 1025 (e.g., a speaker). In some examples, the mobile computing device 1000 incorporates a vibration transducer for providing the user with tactile feedback. In yet another example, the mobile computing device 1000 incorporates a peripheral device port 1040, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one example of a mobile computing device. That is, the mobile computing device 1000 incorporates a system (i.e., an architecture) 1002 to implement some examples. In one example, the system 1002 is implemented as a “smart phone” capable of running one or more applications (e.g., browser, e-mail, calendaring, contact managers, messaging clients, games, and media clients/players). In some examples, the system 1002 is integrated as a computing device, such as an integrated personal digital assistant (PDA) and wireless phone.

According to an aspect, one or more application programs 1050 are loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. According to an aspect, a freehand transformer 150 is loaded into memory 1062. The system 1002 also includes a non-volatile storage area 1068 within the memory 1062. The non-volatile storage area 1068 is used to store persistent information that should not be lost if the system 1002 is powered down. The application programs 1050 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000.

According to an aspect, the system 1002 has a power supply 1070, which is implemented as one or more batteries. According to an aspect, the power supply 1070 further includes an external power source, such as an AC adapter or a powered docking cradle that supplements or recharges the batteries.

According to an aspect, the system 1002 includes a radio 1072 that performs the function of transmitting and receiving radio frequency communications. The radio 1072 facilitates wireless connectivity between the system 1002 and the “outside world,” via a communications carrier or service provider. Transmissions to and from the radio 1072 are conducted under control of the operating system 1064. In other words, communications received by the radio 1072 may be disseminated to the application programs 1050 via the operating system 1064, and vice versa.

According to an aspect, the visual indicator 1020 is used to provide visual notifications and/or an audio interface 1074 is used for producing audible notifications via the audio transducer 1025. In the illustrated example, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. According to an aspect, the system 1002 further includes a video interface 1076 that enables an operation of an on-board camera 1030 to record still images, video stream, and the like.

According to an aspect, a mobile computing device 1000 implementing the system 1002 has additional features or functionality. For example, the mobile computing device 1000 includes additional data storage devices (removable and/or non-removable) such as, magnetic disks, optical disks, or tape. Such additional storage is illustrated in FIG. 10B by the non-volatile storage area 1068.

According to an aspect, data/information generated or captured by the mobile computing device 1000 and stored via the system 1002 are stored locally on the mobile computing device 1000, as described above. According to another aspect, the data are stored on any number of storage media that are accessible by the device via the radio 1072 or via a wired connection between the mobile computing device 1000 and a separate computing device associated with the mobile computing device 1000, for example, a server computer in a distributed computing network, such as the Internet. As should be appreciated, such data/information are accessible via the mobile computing device 1000 via the radio 1072 or via a distributed computing network. Similarly, according to an aspect, such data/information are readily transferred between computing devices for storage and use according to well-known data/information transfer and storage means, including electronic mail and collaborative data/information sharing systems.

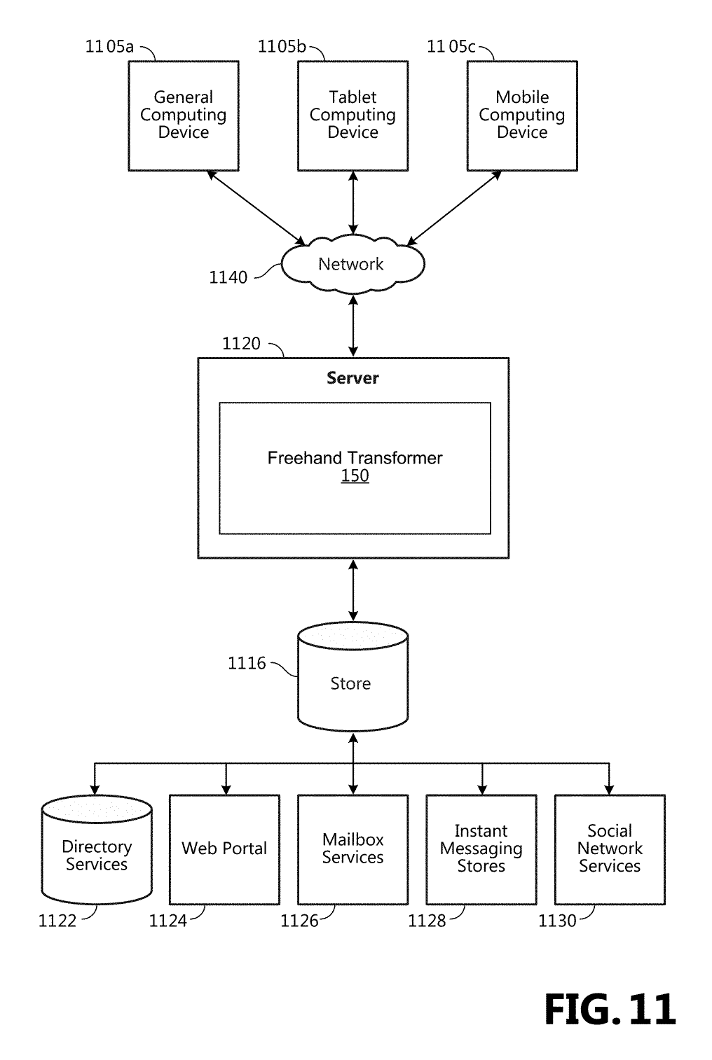

FIG. 11 illustrates one example of the architecture of a system for intelligent detection and manipulation of objects via freehand input as described above. Content developed, interacted with, or edited in association with the freehand transformer 150 is enabled to be stored in different communication channels or other storage types. For example, various documents may be stored using a directory service 1122, a web portal 1124, a mailbox service 1126, an instant messaging store 1128, or a social networking site 1130. The freehand transformer 150 is operative to use any of these types of systems or the like for intelligent detection and manipulation of objects via freehand input, as described herein. According to an aspect, a server 1120 provides the freehand transformer 150 to clients 1105a-c (generally clients 1105). The server 1120 provides the freehand transformer 150 over the web to clients 1105 through a network 1140. By way of example, the client computing device is implemented and embodied in a personal computer 1105a, a tablet computing device 1105b or a mobile computing device 1105c (e.g., a smart phone), or other computing device. Any of these examples of the client computing device are operable to obtain content from the store 1116.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A method for intelligent manipulation of objects via freehand input, comprising:
receiving an object, the object comprising a plurality of strokes;
calculating features of the object based on the plurality of strokes;
displaying a first feature marker associated with a first angle;
displaying a second feature marker associated with a second angle;
receiving a first freehand input comprising a constraint on the first feature marker;
receiving a second freehand input comprising a constraint on the second feature marker; and
updating the features based on the constraints.

2. The method of claim 1, further comprising:
determining whether the constraint on the first feature marker and the constraint on the second feature marker are equivalent; and
in response to determining that the constraint on the first feature marker and the constraint on the second feature marker are equivalent, updating the features to set the second angle equal to the first angle.

3. The method of claim 2, wherein updating the features to set the second angle equal to the first angle includes changing a value of the first angle and a value of the second angle.

4. The method of claim 1, wherein updating the features includes changing a length of a stroke of the plurality of strokes to affect values of at least one of the first angle and the second angle.

5. The method of claim 4, further comprising:
determining whether the first angle and the second angle are defined by a shared stroke;
in response to determining that the first angle and the second are defined by a shared stroke, the shared stroke is the stroke of the plurality of stroke for which the length is changed.

6. The method of claim 1, wherein the first feature marker and the second feature marker are arcs defined at vertices of the object.

7. The method of claim 6, wherein the first freehand input and the second freehand input define symbolic constraints on the first angle and the second angle.

8. A system for intelligent manipulation of objects via freehand input, comprising:
a processor; and
a memory storage device including instructions that when executed by the processor configure the system to:
receive an object, the object comprising a plurality of strokes;
calculate features of the object based on the plurality of strokes;
display a first feature marker associated with a first angle;
display a second feature marker associated with a second angle;
receive a first freehand input comprising a constraint on the first feature marker;
receive a second freehand input comprising a constraint on the second feature marker; and
update the features based on the constraints.

9. The system of claim 8, further configured to:
determine whether the constraint on the first feature marker and the constraint on the second feature marker are equivalent; and
in response to determining that the constraint on the first feature marker and the constraint on the second feature marker are not equivalent, update the features to set the second angle to a different value from the first angle.

10. The system of claim 9, wherein updating the features to set the second angle equal to the first angle includes changing a value of the first angle and a value of the second angle.

11. The system of claim 8, wherein updating the features includes changing a length of a stroke of the plurality of strokes to affect values of at least one of the first angle and the second angle.

12. The system of claim 11, further configured to:
determine whether the first angle and the second angle are defined by a shared stroke;
in response to determining that the first angle and the second are defined by a shared stroke, the shared stroke is the stroke of the plurality of stroke for which the length is changed.

13. The system of claim 8, wherein the first feature marker and the second feature marker are arcs defined at vertices of the object.

14. The system of claim 13, wherein the first freehand input and the second freehand input define symbolic constraints on the first angle and the second angle.

15. A computer readable memory storage device including processor executable instructions for intelligent manipulation of objects via freehand input, comprising:
receiving an object, the object comprising a plurality of strokes;
calculating features of the object based on the plurality of strokes;
displaying a first feature marker associated with a first angle;
displaying a second feature marker associated with a second angle;
receiving a first freehand input comprising a constraint on the first feature marker;
receiving a second freehand input comprising a constraint on the second feature marker; and
updating the features based on the constraints.

16. The computer readable memory storage device including processor executable instructions for intelligent manipulation of objects via freehand input of claim 15, further comprising:
determining whether the constraint on the first feature marker and the constraint on the second feature marker are equivalent;
in response to determining that the constraint on the first feature marker and the constraint on the second feature marker are equivalent, updating the features to set the second angle equal to the first angle; and
in response to determining that the constraint on the first feature marker and the constraint on the second feature marker are not equivalent, updating the features to set the second angle to a different value from the first angle.

17. The computer readable memory storage device including processor executable instructions for intelligent manipulation of objects via freehand input of claim 16, wherein updating the features to set the second angle equal to the first angle includes changing a value of the first angle and a value of the second angle.

18. The computer readable memory storage device including processor executable instructions for intelligent manipulation of objects via freehand input of claim 15, wherein updating the features includes changing a length of a stroke of the plurality of strokes to affect values of at least one of the first angle and the second angle.

9. The computer readable memory storage device including processor executable instructions for intelligent manipulation of objects via freehand input of claim 18, further comprising:
determining whether the first angle and the second angle are defined by a shared stroke;
in response to determining that the first angle and the second are defined by a shared stroke, wherein the shared stroke is the stroke of the plurality of stroke for which the length is changed.

20. The computer readable memory storage device including processor executable instructions for intelligent manipulation of objects via freehand input of claim 15, wherein the first feature marker and the second feature marker are arcs defined at vertices of the object, and wherein the first freehand input and the second freehand input define symbolic constraints on the first angle and the second angle.
